(19) United States
(12) Patent Application Publication
(10) Pub. No.: US 2019/0251600 A1
(43) Pub. Date: Aug. 15, 2019

(54) VEHICLE-MOUNTED DIRECTED ADVERTISEMENT SYSTEM AND METHOD

(71) Applicants: Andres Felipe Cabrera, Davie, FL (US); Andres Vargas, Plantation, FL (US)

(72) Inventors: Andres Felipe Cabrera, Davie, FL (US); Andres Vargas, Plantation, FL (US)

(21) Appl. No.: 15/893,589

(22) Filed: Feb. 10, 2018

(51) Int. Cl. G06Q 30/02; H04W 4/021

(52) U.S. Cl. CPC G06Q 30/0266; H04L 67/12; H04W 4/021

(57) ABSTRACT

A vehicle-mounted directed advertisement system and method enables a marketing user to configure an advertisement campaign, and display the advertisement, in the form of audio-visual digital content, from a vehicle-mounted electronic display that is driven by a driving user, and directed towards a targeted consumer in a target geographic marketing area. The advertisement is designed by the marketing user and directed towards the targeted consumer through the electronic display. The audio-visual content is stored on a server and communicated to the electronic display. The location of driving user's portable communication device is tracked and generates audio-visual content based on its position relative to a geographic fence marketing perimeter. The driving user is payed to mount the electronic display and navigate through the geographic fence, so as to engage a targeted consumer with the advertisement. A dynamic traffic message displays on the electronic display when a traffic event occurs.

### BACKGROUND OF THE INVENTION

Typically, vehicle-mounted advertising signs have been used by various businesses for advertising and increasing notoriety and name recognition. The use of vehicles, such as taxicabs, vans, and buses, to carry advertising signs is well known. These signs are often mounted to the tops of the vehicles to display the advertisement to both pedestrians and motorists. The use of these signs can be particularly beneficial for businesses that deliver products to their customers, such as pizza delivery services, to make potential customers aware of the business, its presence in the area and that the business offers a delivery service. These signs are static, and cannot adapt to changing demographics or numbers of potential viewers.

Often, these vehicle window-mounted advertising signs utilize suction cups to attach to the outer surface of the window, a brace and a hook portion to pass across the top of a vehicle window. In order for the prior window-mounted advertising signs to be securely fastened to the vehicle window while the vehicle is moving, the window must be completely rolled up such that the advertising sign is pinched between the window and the window frame of the vehicle. Such suction cup fastening mechanisms often cannot support a heavier digital sign.

There are advertising systems and methods used for displaying advertising on the back or side of a moving vehicle. These systems are sufficiently dynamic, so as to periodically change the advertising based upon the GPS information or other information received by a controller on the displaying sign. Often, a geo-fence may be used to determine when the advertisement should be changed. However, these digital types of signs are not easily edited in real time. Also, these systems utilize a geo-fence that cannot be increased or decreased in range from a remote area.

Therefore, a need exists to overcome the problems with the prior art as discussed above.

### SUMMARY OF THE INVENTION

The invention provides a device and method for a vehicle-mounted directed advertisement system and method that overcomes the hereinafore-mentioned disadvantages of the heretofore-known devices and methods of this general type and that enables a marketing user to configure an advertisement campaign, and display the advertisement, in the form of audio-visual digital content, from a vehicle-mounted electronic display that is driven by a driving user, and directed towards a targeted consumer in a target geographic marketing area.

With the foregoing and other objects in view, there is provided, in accordance with the invention, a vehicle-mounted directed advertisement system and method that enables a marketing user to configure an advertisement campaign for direct marketing to a targeted consumer. The advertisement or promotion is configured in the form of an audio and visual digital content. The advertisement is selectively displayed from a vehicle-mounted electronic display that is driven by a driving user, based on the range of the geographic fence marketing perimeter, images captured by a camera, and demographics of the targeted consumer. The advertisement may include, without limitation, a promotion, a company logo, an address, and other pertinent marketing messages the marketing user designs and directs towards the targeted consumer through the vehicle-mounted electronic display. The targeted consumer responds to the advertisement or promotion by soliciting the business of the marketing user, downloading an app of the system, reviewing the advertisement, and participating in a rewards or loyalty program.

In some embodiments, the method may include an initial Step of configuring a marketing layout, by a marketing user, for either audio and/or visual digital content. A Step comprises receiving, through at least one server, from the marketing user: a digital geographic fence marketing perimeter representing a target geographic marketing area; and the audio and visual digital content identifying a business of the marketing user. A Step includes navigating the vehicle, by a driving user, through the target geographical marketing area.

In some embodiments, a step comprises locating a geographic position of at least one of a portable communication device of the driving user and an electronic display coupled to a window of a vehicle occupied by the driving user. A Step includes communicating the at least one of the audio and visual digital content to the portable communication device of the driving user communicatively coupled to the at least one server over a network.

In some embodiments, a step may include communicating, through the portable communication device, the at least one of the audio and visual content to a receiver communicatively coupled to the portable communication device, the receiver housed on the electronic display. A Step comprises displaying, when the at least one of the portable communication device of the driving user and the electronic display is located within the digital geographic fence marketing perimeter, the at least one of an audio and visual content on the electronic display. A Step includes capturing an image with a camera of at least one of the following: a proximal vehicle, a license plate, a vehicle occupant, and a pedestrian.

Another step of the method includes identifying a targeted consumer based on at least one of the following: the captured image, a business category, business hours, an age group, a promotion, the captured image, at least one demographic data, a geographical marketing area, a time period, and an address. In some embodiments, a Step comprises displaying to the targeted consumer, through the electronic display, the audio and visual content. A Step includes downloading, by the targeted consumer, a promotion or information pertinent to the marketing user, when the audio and visual content displays on the electronic display.

In some embodiments, a step may include paying, by the marketing user, the driving user for coupling the electronic display to the window of the vehicle, maintaining communication between the portable communication device and the at least one server, and navigating through the preferred target geographic marketing area. A final Step includes displaying a dynamic traffic message when a traffic event occurs.

In accordance with another feature, an embodiment of the present invention is that the digital geographic fence marketing perimeter comprises a unit of length, a radius, a neighborhood, and a highway.

In accordance with a further feature of the present invention, the digital geographical fence marketing perimeter comprises an interactive map.

In accordance with a further feature of the present invention, the audio and visual digital content includes at least one of the following: a company logo, a promotion, a price list, a direction, a website address, a phone number, and a physical address.

In accordance with the present invention, the method further comprises a step of configuring a marketing layout by the marketing user for the audio and visual digital content.

In accordance with a further feature of the present invention, the step of configuring a marketing layout, includes at least one of the following: uploading a graphic, uploading a video, entering coordinates for the digital geographic fence marketing perimeter, viewing layout option of the audio and visual digital content, and viewing a full screen preview of the audio and visual digital content.

In accordance with a further feature of the present invention, the method further comprises a step of displaying to the targeted consumer, through the electronic display, the audio and visual content.

In accordance with a further feature of the present invention, the promotion or information about the marketing user is configured as a quick response code.

In accordance with a further feature of the present invention, the method further comprises a step of navigating the vehicle, by the driving user, through the target geographical marketing area.

In accordance with a further feature of the present invention, the step of navigating the vehicle, by the driving user, through the target geographical marketing area, further comprises indicating to the driving user, by the marketing user, a preferred target geographic marketing area.

In accordance with a further feature of the present invention, the method further comprises a step of displaying on the portable communication device, by the driving user, at least one of the following: a monthly statement, a distance driven, and a payment request.

Although the invention is illustrated and described herein as embodied in a vehicle-mounted directed advertisement system and method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the electronic display.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram view of an exemplary vehicle-mounted directed advertisement system, in accordance with an embodiment of the present invention;

FIG. 2 is a perspective view of an exemplary vehicle window carrying a vehicle-mounted electronic display having an audio and visual digital content, in accordance with an embodiment of the present invention;

FIGS. 3A and 3B are perspective views of vehicles, where FIG. 3A shows an automobile, and FIG. 3B shows a train, in accordance with an embodiment of the present invention;

FIG. 4 is a perspective view of an exemplary display fastener, in accordance with an embodiment of the present invention;

FIGS. 5A-5C are perspective views of an electronic display attaching to the window of the vehicle through at least one display fastener, where FIG. 5A shows a top bracket that works with the suction cups fastening mechanisms to retain the electronic display, FIG. 5B shows the electronic display separated from the window, and FIG. 5C shows the electronic display operable with the vehicle, in accordance with an embodiment of the present invention;

FIGS. 6A-6D are perspective views of a suction cup mechanism, where FIG. 6A shows the suction cup mechanism that is effective for sticking with glass windows, a threaded cup tightening member, and a display fastening mechanism attached to both sides of the window, FIG. 6B shows the threaded cup tightening member rotatable to press and release the suction cup against the window, FIG. 6C shows the suction cup disposed generally coplanar with the window, and FIG. 6D shows a perspective view of the suction cup, in accordance with an embodiment of the present invention;

FIG. 7 is a flowchart of an exemplary vehicle-mounted directed advertisement method, in accordance with an embodiment of the present invention;

FIG. 8 is a marketing user log in interface, in accordance with an embodiment of the present invention;

FIG. 9 is an options menu for designing advertisements and promotions for the marketing user, in accordance with an embodiment of the present invention;

FIG. 10 is a second options menu for designing advertisements and promotions for the marketing user, in accordance with an embodiment of the present invention;

FIG. 11 is an interactive map for setting the digital geographic fence marketing perimeter, in accordance with an embodiment of the present invention;

FIG. 12 is a business and demographic interface that provides selective options for designing the advertisement and promotion, in accordance with an embodiment of the present invention;

FIG. 13 is a coupon interface for use by the marketing user that provides selective options for designing the advertisement and promotion, in accordance with an embodiment of the present invention;

FIG. 14 is a payment interface for use by the marketing user that provides selective options for designing the advertisement and promotion, in accordance with an embodiment of the present invention;

FIG. 15 is a driving user log in interface, in accordance with an embodiment of the present invention;

FIG. 16 is a driver work log interface that helps the driving user keep track of driving parameters and hours worked, in accordance with an embodiment of the present invention;

FIG. 17 is a geographic driving area interface to help a driving user navigate through the geographic fence marketing perimeter, in accordance with an embodiment of the present invention;

FIG. 18 is a financial records interface that allows the driving user to record and view payments for time and distance driven in the geographic fence marketing perimeter, in accordance with an embodiment of the present invention;

FIG. 19 is a targeted consumer log in interface, in accordance with an embodiment of the present invention;

FIG. 20 is a promotion download interface that allows the targeted consumer to view a promotion and select, save, like, unlike, or delete the promotion, in accordance with an embodiment of the present invention;

FIG. 21 is a rewards interface that supports a reward program for the targeted consumer, in accordance with an embodiment of the present invention;

FIG. 22 is an earnings summary interface that is used to show the targeted consumer the number of points, stars, dollars, etc. accumulated and available in the targeted consumer's account, in accordance with an embodiment of the present invention;

FIG. 23 is a gift cards interface that shows the targeted consumer the number of gift cards accumulated, in accordance with an embodiment of the present invention;

FIG. 24 is a coupons interface that shows the targeted consumer the number of coupons accumulated, in accordance with an embodiment of the present invention;

FIG. 25 is a Mapped Drive option that allows the targeted consumer to view the map, in accordance with an embodiment of the present invention;

FIG. 26 is a promotion like or unlike interface that allows the targeted consumer to view advertisements and promotions that have been liked or disliked from the like/unlike option, in accordance with an embodiment of the present invention;

FIG. 27 is a standard vehicle-mounted electronic display is used to display the audio and visual digital content for the advertisement, in accordance with an embodiment of the present invention;

FIGS. 28A-28C are a first set of dynamic traffic messages, in accordance with an embodiment of the present invention;

FIGS. 29A-29B are a second set of dynamic traffic messages, in accordance with an embodiment of the present invention;

FIG. 30 is block diagram, illustrating an exemplary network of data processing system, in accordance with an embodiment of the present invention; and

FIG. 31 is a block diagram of an exemplary personal computing device and/or vehicle-mounted display, in accordance with an embodiment of the present invention.

### DETAILED DESCRIPTION OF INVENTION

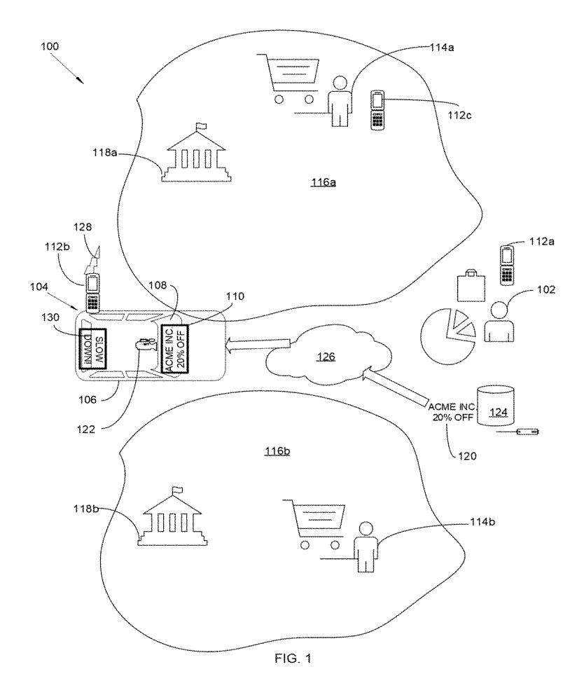

The invention described herein provides a vehicle-mounted advertisement and method operation that overcomes known disadvantages of those known devices and methods of this general type and that includes firmware and software providing real-time smart advertisement based on a display screen mounted, respectively, on a plurality of vehicles, such as those shown in FIG. 1, e.g., cars, trains, monorails, metros, etc. Although the invention is illustrated and described herein as embodied in a vehicle-mounted advertisement and method operation, it is, nevertheless, not intended to be limited to the details shown because various modifications and structural changes may be made therein without departing from the spirit of the invention. Additionally, well-known elements of exemplary embodiments of the invention will not be described in detail or will be omitted so as not to obscure the relevant details of the invention.

It is to be understood that the disclosed embodiments herein are merely exemplary of the invention, which can be embodied in various forms. Therefore, specific structural and functional details disclosed herein are not to be interpreted as limiting, but merely as a basis for future claims and as a representative basis for teaching one of ordinary skill in the art to variously employ the present invention in virtually any appropriately detailed structure. Further, the terms and phrases used herein are not intended to be limiting; but rather, to provide an understandable description of the invention. It is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the display, wherein “transverse” should be understood to mean a direction corresponding to a direction opposite of the longitudinal direction. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The attached figures are incorporated in and form part of the specification, and serve to further illustrate various embodiments and explain various principles and advantages all in accordance with the present invention. Moreover, it is believed that the invention will be better understood from a consideration of the following description in conjunction with the drawing figures, in which like reference numerals are carried forward.

Referring now to FIG. 1, one embodiment of the present invention is shown as a block diagram view. FIG. 1, along with other figures in the specification, show several advantageous features of the present invention, but, as will be described below, the invention can be provided in several shapes, sizes, combinations of features and components, and varying numbers and functions of the components.

In some embodiments, the vehicle-mounted directed advertisement system 100 enables a marketing user 102 to configure an advertisement campaign, and display an advertisement, in the form of at least one of the audio and visual digital content 120, from a vehicle-mounted electronic display 110 that is driven by a driving user 104, and directed towards a targeted consumer 114a, 114b in a target geographic marketing area 118a, 118b.

The marketing user 102 designs and lays out an advertisement or promotion that may include, without limitation, a promotion, a company logo, an address, a rewards program, and other pertinent marketing messages the marketing user 102 designs and directs towards the targeted consumer 114a-b. Exemplary audio-visual content 120 may include still images, sounds, text, video clips, a combination of the same, and/or other audio-visual content regarding the specific type of advertisement that is available for sale by the marketing user 102 or an administrator of the system 100.

In one non-limiting embodiment, an electronic display 110 is mounted to a window 108 of a vehicle 106 by a driving user 104. The advertisement or promotion displays on the electronic display, changing in real time, based on the edits of the marketing user 102 and the position of the vehicle 106 relative to a digital geographic fence marketing perimeter 116a-b. The marketing user 102 may pay the driving user 104 to mount the electronic display 110, and navigate the vehicle 106 through the geographic fence marketing perimeter 116a, 116b. In this manner, the advertisement is strategically directed to a targeted consumer 114a-b within the digital geographic fence marketing perimeter 116a-b.

The system 100 is especially unique in that the geolocation of the driving user 104 is monitored by tracking a receiver 128 in a portable communication device 112b of the driving user 104. The advertisement triggers on and off, and changes based on the position of the vehicle 106 relative to the geographic fence marketing perimeter 116a-b. Though other tracking means known in the art, e.g. GPS, may also be used. At least one server 124 stores and transmits the audio and visual digital content 120. The driving user 104 has a portable communication device 112b that is communicatively coupled to the server 124 over a network 126. The audio and visual content 120 is communicated to a receiver 128 that is communicatively coupled to the portable communication device 112b, and housed on the electronic display 110. In this manner, when the driving user 104 navigates through the digital geographic fence marketing perimeter 116a, 116b, the audio and visual digital content 120 selectively displays.

The targeted consumer 114a-b responds to the advertisement or promotion by soliciting the business of the marketing user, downloading an app of the system, reviewing the advertisement, and participating in a rewards or loyalty program. Further, the system 100 enables the targeted consumer 114a, 114b to be identified for targeted advertisements through use of a camera 122 that is operable on the electronic display 110. The camera 122 works to capture an image of a proximal vehicle, a license plate, a vehicle passenger, a building, and a pedestrian—in essence, all potentially targeted consumers. Further, if the targeted consumer 114a-b has downloaded information about the marketing user or advertisement, the demographics and personal information of the targeted consumer 114a-b may also be collected and analyzed for targeted advertising.

In yet another embodiment of the system 100, the electronic display 110 may display a dynamic traffic message 130a-d when a traffic event occurs. The dynamic traffic message 130a-d can interrupt the advertisement or promotion. Thus, the dynamic traffic message 130a-d supersedes the audio and visual content 120 of the advertisement for enhanced traffic safety. Examples of traffic messages may include: “Slow Down” 130a, or “stop” 130b, “Slow Bumper to Bumper Traffic” 130c, and “OBD Stop command in Traffic” 130d.

Looking again at the block diagram of the advertising system 100, an electronic display 110 is configured to be customizable by a marketing user 102 through a software application communicatively coupled thereto and housed, in one embodiment, on the marketing user's 102 portable communication device 112a, such as a cellular phone. The marketing user's portable communication device 112a may include and house known geo-location tools, e.g. GPS, and applications utilized to identify a location of the portable communication device 112b of a driving user 104.

In another embodiment, the location of the driving user's 104 portable communication device 112b is utilized to generate audio-visual content for the vehicle-mounted display 110, such as specific types of directed or non-directed advertisements (e.g., restaurants, bars, or other business in the proximity or region of the user). Exemplary audio-visual content 120 may include still images, sounds, text, video clips, a combination of the same, and/or other audio-visual content regarding the specific type of advertisement that is available for sale by the marketing user 102 or an administrator of the system 100.

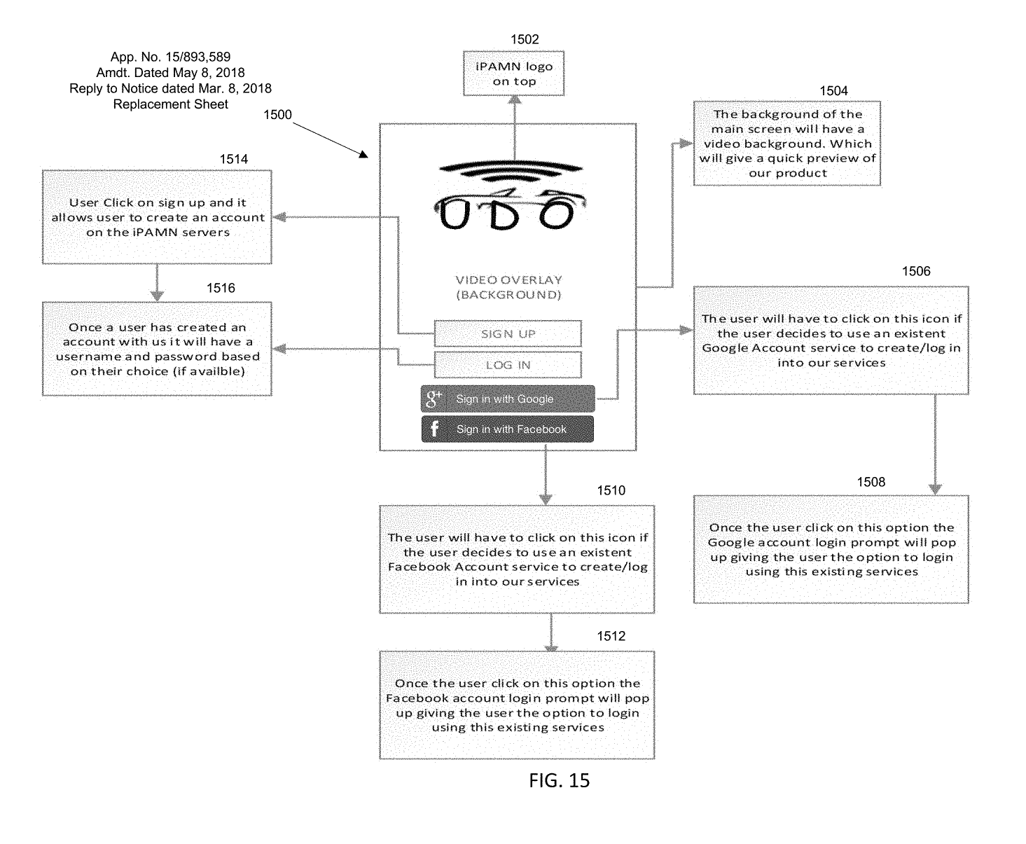

The electrical and communication components of the driving user's 104 portable communication device 112b, as shown in FIGS. 15-18, may also serve as the communication means to relay or convey audio and/or visual content to the vehicle-mounted electronic display 110. In other embodiments, electrical and communication components of the vehicle 106 may serve as the communication means to relay or convey audio and/or visual content to the vehicle-mounted electronic display 110, or components associated therewith, may house or store audio and/or visual content 120 for display based on the location of the display, i.e., determined by one or more location means such as a GPS.

Specifically, in one embodiment, the marketing user 102 and/or administrator will be able to upload and/or design an advertisement or other content through the portable communication device 112a, or through an administrator's server, input/output device(s), and/or processing device(s), by uploading content, e.g., a picture of their choice or logo, a video to play scrolling messages and location to at least one server 124. The audio and visual digital content 120 may then be communicated to the vehicle-mounted electronic display 110 for production to surrounding or neighboring vehicles, or a targeted consumer 114a-b. Additionally, the system enables the display of a dynamic traffic message 130a-d, information, and content, e.g., traffic information or emergency alerts, may also be relayed to the vehicle-mounted electronic display 1108 from the driving user's portable communication device 1104 and/or the administrator server 1106 to indicate a traffic event.

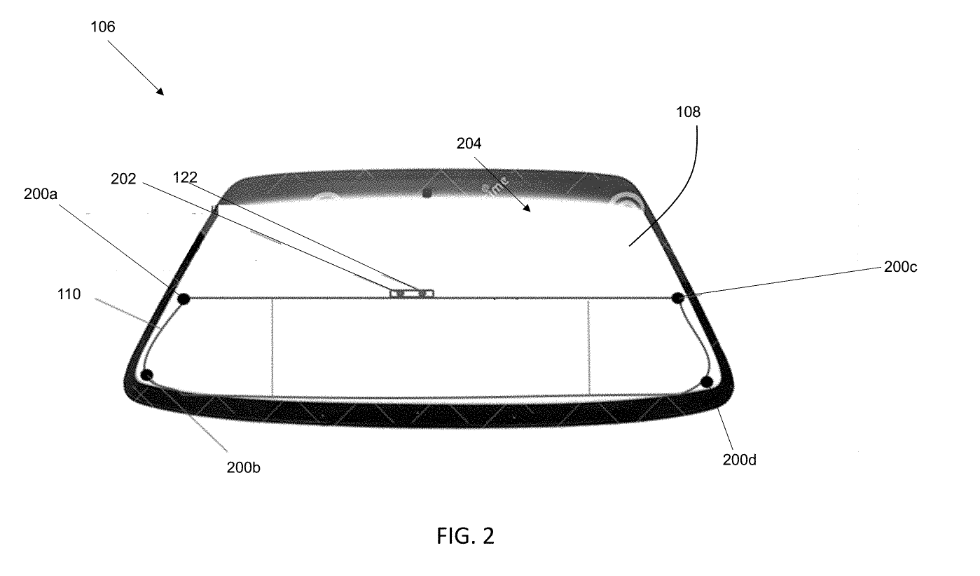

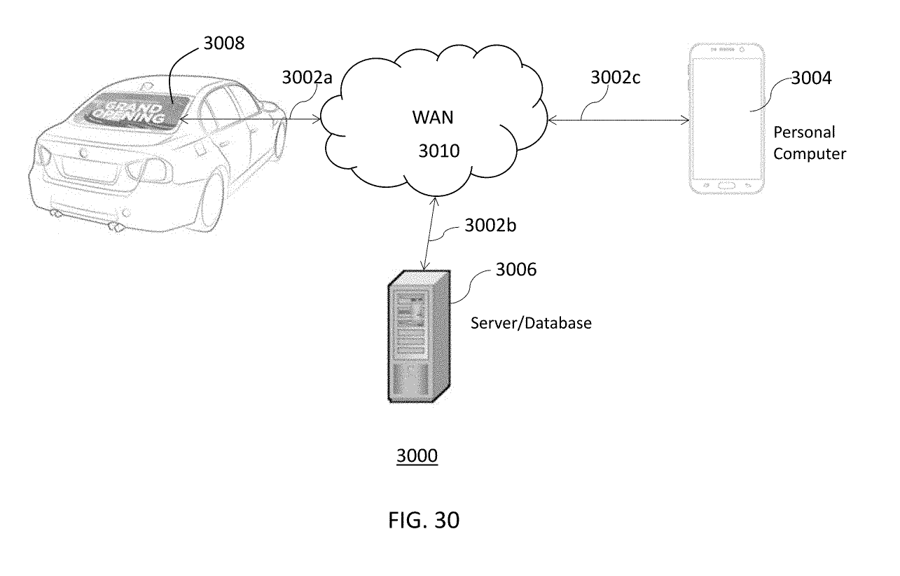

The first example of a vehicle-mounted directed advertisement system 100, as shown in FIG. 2, includes a window 108 of a vehicle 106, such as a rear vehicle window having a removably couplable electronic display 110 that is communicatively coupled to a network 126 (exemplified in FIG. 30). The electronic display 110 is configured to display, in real time: a company logo, a promotion, an address, a phone number, and the like. These advertisements are configured by, and representative of the marketing user 102.

In one embodiment, the electronic display 110 is a flat digital panel consisting of LEDs or other light emitting components that work to display audio and visual digital content 120 designed and selected for real time display by the marketing user 102. The marketing user 102 can configure a layout for a targeted advertisement to be selectively displayed on the electronic display 110, dependent on geolocation of the electronic display 110, demographics of targeted consumer 114a-b, time period, etc. The electronic display 110 is advantageously facing outwardly away from an interior 204 of the vehicle 106 for viewing by a surrounding public, e.g., one or more targeted consumers 114a-b.

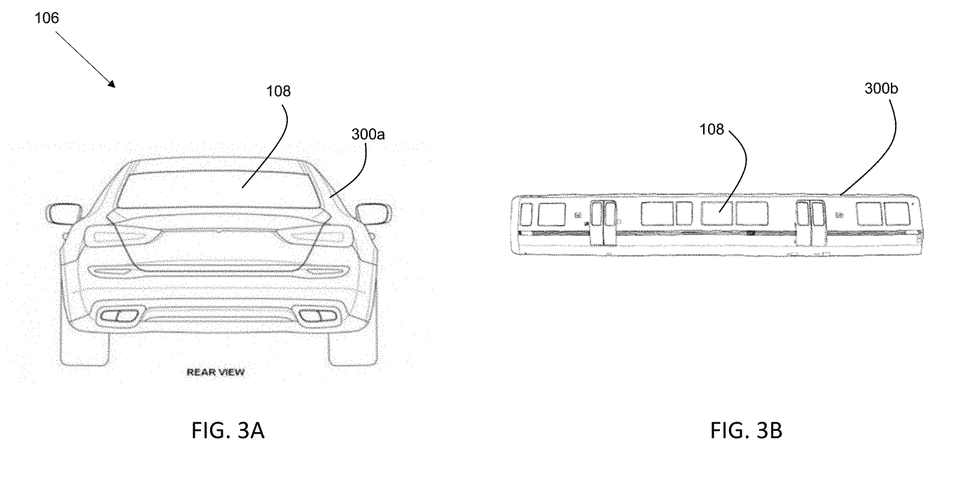

The vehicle 106 on which the electronic display of the advertisement is carried may include an automobile 300a (FIG. 3A), and a train 300b (FIG. 3B). Though in other embodiments, the vehicle may include, without limitation, a bus, a truck, a boat, and an airplane. In any case, the vehicle 106 comprises a rear window 108, side window, or front window on which the electronic display 110 may be mounted for optimal visibility of the audio and visual digital content 120.

In some embodiments, the electronic display 110 may also include one or more cameras 122 used to capture an image from the electronic display 110 to the proximal area around the vehicle 106. As described below, the captured image is used to identify and market to the targeted consumer 114a-b. The cameras 122 are operably configured to obtain vehicle identity information from vehicles and targeted consumers in proximity to the vehicle 106 of the driving user 104.

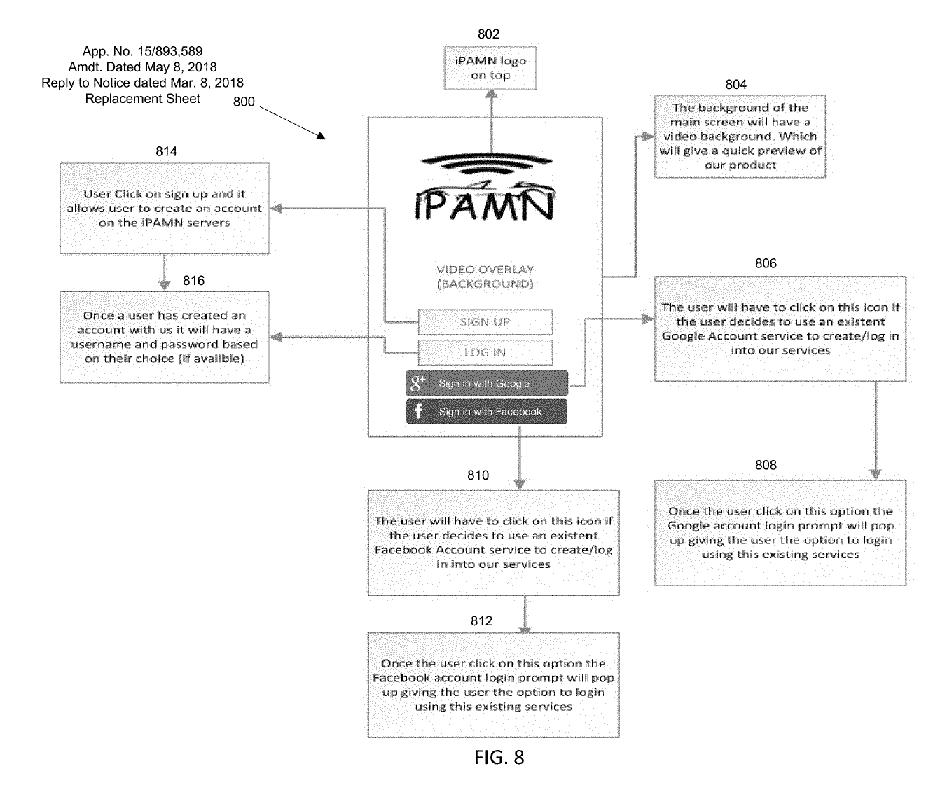

Some methods and systems to obtain said vehicle identity information are discussed, for example, in U.S. Pat. Nos. 5,635,981 (Ribacoff), 7,902,978 (Pederson), 9,318,009 (Pederson), and 9,563,814 (Wilbert et al.) and U.S. Patent Application Publication Nos. 2013/0093886 (Rothschild) and 2016/0379487 (Voeller et al.), all of which are incorporated herein by reference. This vehicle identity information will then be used to provide directed advertisement to the neighboring or surrounding vehicles, e.g., vehicle leasing specials by a car dealership to a particular vehicle make and/or vehicle model of said neighboring or surrounding vehicle. Exemplary user-interfaces associated with the marketing user's 102 portable communication device 112a is depicted in FIGS. 8-26.

Looking back at FIG. 1, the electronic display 104 may also include an illumination portion 110, such as a light dimmer, that enhances viewing of the advertisement message and audio and visual digital content 120 that displays on the electronic display 104. The lighting may especially be useful at night when ambient lighting is minimal. The illumination portion 110 may also work with the camera 108 to enhance the captured image of the targeted consumer 114a-b, proximal vehicle, and vehicle passengers. The illumination portion 110 may include, without limitation, a light bulb, an LED, and a fluorescent light source.

Exemplary structures to removably couple the vehicle-mounted display to the vehicle window is depicted in FIGS. 2, 4, and 6A-6D. Turning now to FIG. 2, the electronic display 110 attaches to the window 108 of the vehicle 106 through at least one display fastener 200a, 200b, 200c, 200d. The display fastener 200a-d is configured to securely retain the electronic display 110 against the window 108 of the vehicle 106 in a manner that optimizes viewing of the electronic display 110 and advertisements, company logos, and promotions displayed thereon.

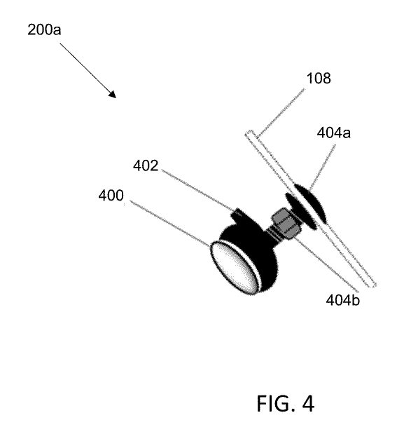

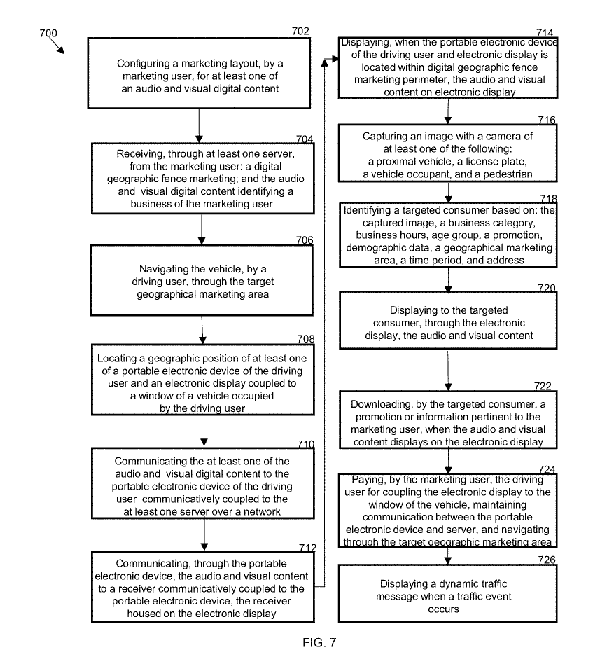

In one embodiment referenced in FIG. 4 and FIGS. 6A-6D, the display fastener 200a-d comprises a suction cup 400 that sticks to the surface of the window 108. A cup tightening member 402 presses the suction cup 400 against the window. A display fastening mechanism 404a, 404b is operable to press the cup tightening member 402 from both sides of the window 108, to restrain the suction cup 400 to the electronic display 110. Though in other embodiments, other fastening mechanisms may be used to securely retain the electronic display 110 against the window 108.

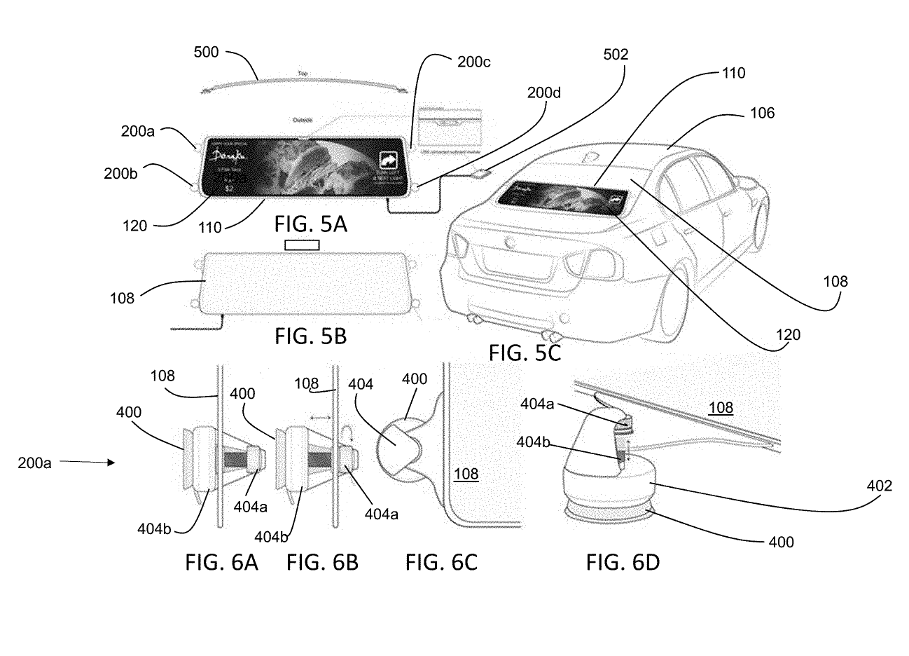

FIGS. 5A-5C illustrate various views of the electronic display 110 attaching to the window 108 of the vehicle 106 through at least one display fastener 200a-d. FIG. 5A references a top bracket 500 that works with the suction cups fastening mechanisms to retain the electronic display 110 flush with the rear window of the vehicle 106. FIG. 5B shows the electronic display 110 separated from the window 108 and ready for operation. FIG. 5C shows the electronic display 110 operable with the vehicle 106. The electronic display 110 is expanded fully across the rear window to optimize viewing of the audio and visual digital content 120.

Turning now to FIG. 6A, the display fastener 200a-d provides a unique suction cup 400 mechanism that is effective for sticking with glass windows known in the art of vehicles. A threaded cup tightening member 402 and display fastening mechanism 404a-b attach to both sides of the window 108, and are rotatable by the driving user 104 to press and release the suction cup 400 against the window 108 (FIG. 6B). In this manner, the display fastening mechanism 404a, 404b is configured to operate on both sides of the window 108, so as to restrain the suction cup 400 to the electronic display 110. As FIG. 6C shows, the suction cup 400 is disposed generally coplanar with the window 108, so as to minimize space usage, creating an efficient display arrangement. Finally, FIG. 6D shows a perspective view, illustrating the height of the display fastener 200a as being sufficient for a thumb and finger to operate the tightening member 402 and display fastening mechanism 404a-b.

Looking again at FIG. 5A, the electronic display 110 may also include a content input device 502 that is hard wired to communicate audio and visual digital content 120 directly to the electronic display 110. The content input device 502 enables the audio and visual digital content 120 to be edited independently of the server 124 communication. Thus, both communication with the server 124 over the network 126, and the content input device 502 control the audio and visual digital content 120. The content input device 502 may be useful if the network is inoperable, or if the marketing user 102 requires a small edit to the advertisement and does not want to communicate new data to the server 124.

FIG. 7 illustrates an exemplary vehicle-mounted directed advertisement method 700 enables a marketing user 102 to configure an advertisement campaign, and display an advertisement, in the form of at least one of the audio and visual digital content 120, from a vehicle-mounted electronic display 110 that is driven by a driving user 104, through consumer-driven, targeted means for engaging a targeted consumer 114a-b.

The method 700 may include an initial Step 702 of configuring a marketing layout, by a marketing user, for at least one of an audio and visual digital content 120. The marketing user 102 designs a custom-tailored advertisement for marketing and promoting a product or service. This is in the form of an audio and visual digital content 120. The marketing user 102 also determined the digital geographic fence marketing perimeter 116a-b, the demographics of targeted consumers, and other directed advertising parameters through use of a downloadable app on the targeted consumer's portable communication device 112c.

The geographic fence (or “geofence”) marketing perimeter 116a-b can be included under a geofence profile associated with a marketing user 102, and can include various types of information. According to various aspects of the concepts and technologies described herein, each geofence profile may include boundary data that defines geographic boundaries of an area to be encompassed by a geofence. For example, if a geofence profile is created for a particular marketing user, the geofence profile can include boundary data specifically selected by the marketing user. Boundary data can define a geographic area or region that corresponds to a particular geography region or distance. Thus, for example, the boundary data can define three or more coordinates (e.g., GPS coordinates) such that imaginary lines drawn between the three or more coordinates can define an area bound by the boundaries. It should be understood that other types of boundary data can be included such as, for example, street names such that an area associated with a geofence profile can be bound by roads or streets, etc.

The geofence profile(s) may also specify actions, events, privileges, capabilities, triggers, and the like, which may apply when a device, s the portable communication device 112c such as the portable communication device 112b, enters or leaves a geofence associated with a geofence profile. One exemplary includes autonomously or automatically activating the display directly coupled to the window of the vehicle 106. These actions, events, privileges, capabilities, triggers, and the like can be tailored by administrators or marketing users 102 when creating a geofence profile. Thus, when a device enters or leaves a geofence associated with a geofence profile, the marketing user 102 (or other entity) can be notified, in some embodiments. In some other embodiments, document, application, or other resource usage privileges can be granted or revoked when the portable communication device 112c enters or leaves a geofence associated with a geofence profile.

Geofence profile management data may include one or more preferences or settings (labeled as “preferences/settings” in the user interface presented to the user). The preferences and/or settings can define various options associated with the geofence profiles. Thus, according to various embodiments the preferences and settings can include data representing an option to enable or disable the geofence profile, an option to notify a driving user when he or she enters into or leaves a boundary associated with a geofence profile, an option to display a message or alert on a screen associated with the portable communication device 112c when the device enters into or leaves a geofence associated with a geofence profile, an option to display an indicator when within a geofence associated with a geofence profile, an option to display an indicator when outside of all geofences, combinations thereof, or the like. Additional and/or alternative options can be included, in some embodiments, and as such, the above examples should not be construed as being limiting in any way.

As FIG. 8 references, the marketing user 102 initiates the design of the advertisement through an advertisement log in interface 800 that is viewable from the portable communication device 112c. A company logo 802 of the marketing user is visible at the top of the screen. In some embodiments, a video background 804 shows the marketing user 102 the product or service that is being marketed. This helps the marketing user 102 to better envision the layout of the advertisement. The marketing user 102 may choose to log in to the system 100 through a Google™ account 806 if the marketing user 102 decides to use Google services. Once the marketing user 102 selects the Google sign in, a pop-up icon 808 for Google™ appears to enable log in.

In some embodiments, the advertisement log in interface 800 allows the marketing user 102 to log in to the system 100 through an existing Facebook™ account 810 if the marketing user 102 decides to use Facebook™ services. Once the marketing user 102 selects the Facebook™ sign in, a pop-up icon 812 for Facebook™ appears to enable log in. The marketing user 102 also has the option of logging in through a server 814, such as an iPAMN server, for example. Once the marketing user 102 has logged into the server, a user name and password option 816 appears for the user to complete the log in. Thus, the marketing user 102 has the option of logging in through Google™, Facebook™, and a server. Though in other embodiments, other log in options may be used.

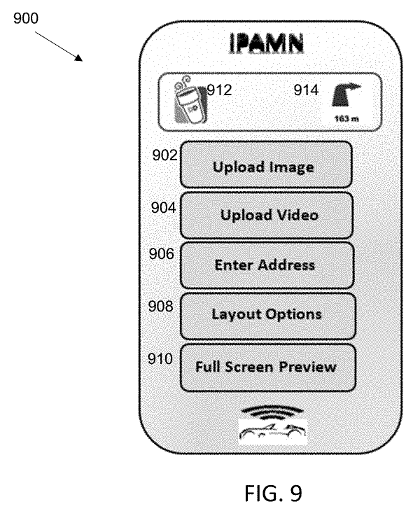

In one embodiment shown in FIG. 9, the log in interface 800 takes the marketing user 102 to an options menu 900, consisting of the following options: 1) uploading an image 902; 2) uploading a video 904; 3) entering an address 906; 4) laying out the audio and visual digital content 908; and previewing a full screen 910. A company logo 912 is also visible from the menu, as are street directions 914 to the physical store front of the marketing user 102 viewable on the options menu 900.

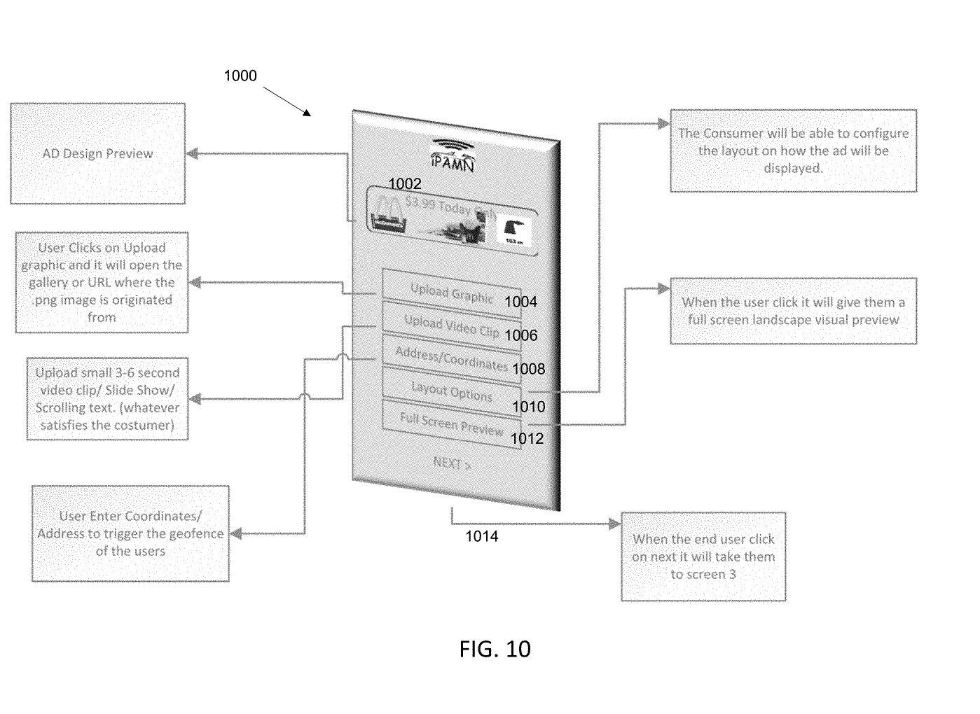

Turning now to FIG. 10, a second option menu 1000 may further provide the marketing user 102 with other advertisement designing option that optimize the audio and visual digital content 120. In some embodiments, the marketing user 102 may select to preview the advertisement and promotion design layout 1002 from the second option menu 1000. The preview by the marketing user may include visually inspecting the audio and visual digital content layout. For example, the marketing user 102 views the size of the company logo in relation to a promotion, or to see the amount of a discount for a product or service. The marketing user 102 may also select to upload a graphic 1004, such as a logo, location, or informational graphic, to the advertisement or promotion.

In continuing to design the advertisement, the marketing user 102 may also upload a video clip 1006. The video may include a commercial or other pertinent information. The marketing user 102 may also provide address and coordinates 1008 for the company. The coordinates can also be used to set the digital geographic fence marketing perimeter 116a-b. The marketing user 102 may also review layout option 1010. The marketing user 102 can configure the layout for the entire advertisement with this option. The marketing user 102 may also see a full screen preview 1012. This can include a landscape view of the visual graphics uploaded earlier. In some embodiments, the second option menu 1000 provides a next button 1014 that allows the marketing user 102 to view additional options for designing the advertisement and promotion.

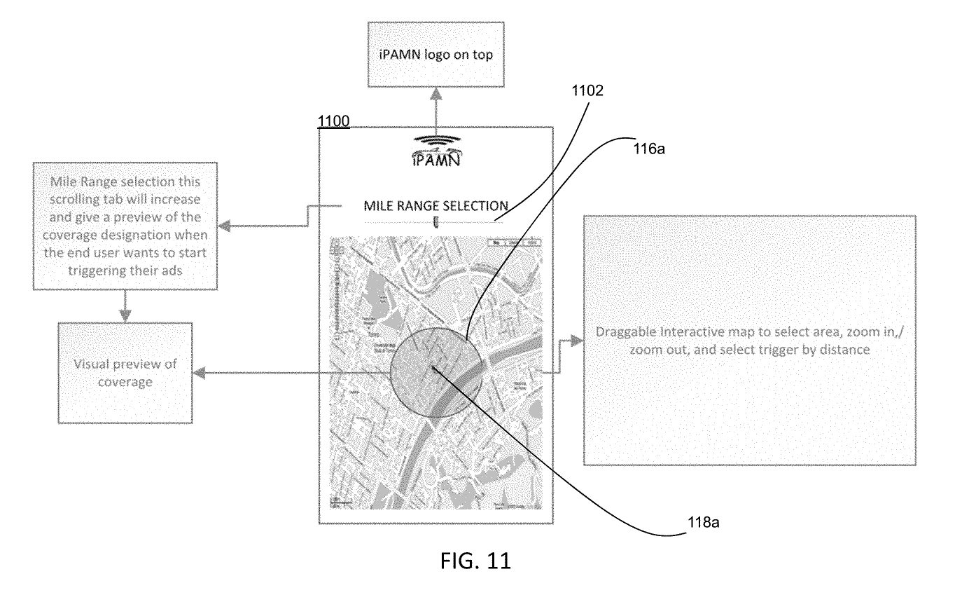

A Step 704 comprises receiving, through at least one server, from the marketing user: a digital geographic fence marketing perimeter representing a target geographic marketing area; and the audio and visual digital content identifying a business of the marketing user 102. As FIG. 11 shows, the marketing user 102 sets the digital geographic fence marketing perimeter 116a-b through use of an interactive map 1100. The marketing user 102 can drag and drop the area to increase or decrease the size thereof, zoom in, zoom out, and set the trigger for the audio and visual digital content 120 on the electronic display 110. The interactive map 1100 provides the marketing user 102 with the flexibility to target the consumers based on their geolocation.

The interactive map 1100, in essence, sets the perimeter for activation of the audio and visual digital content 120 on the electronic display 110. In one embodiment, the interactive map 1100 includes a mile range selector 1102. The mile range selector 1102 provides a scrolling tab that increases, decreases, and provides a preview of the coverage destination and perimeter for triggering the audio and visual digital content 120 on the electronic display 110.

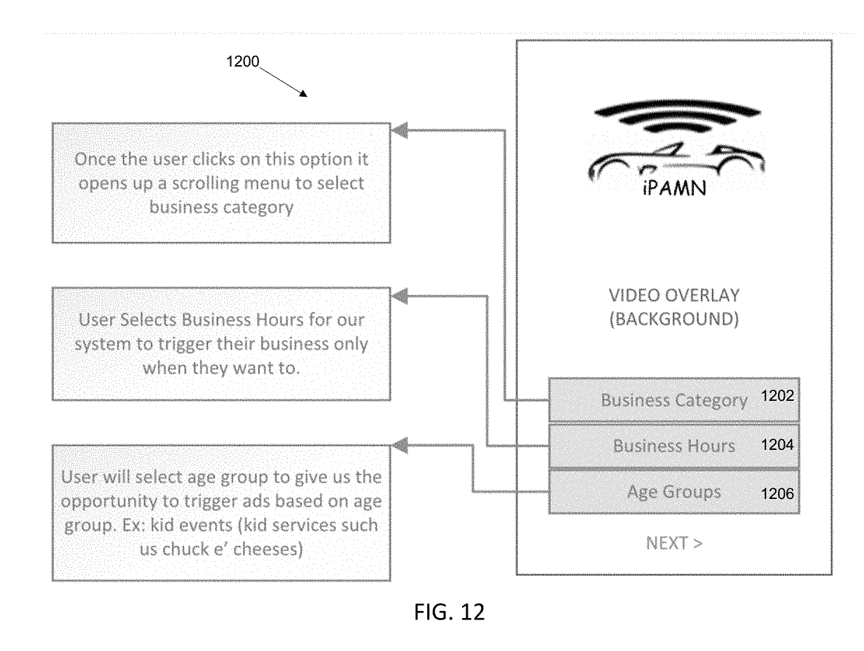

In yet other embodiments of the system 100 shown in FIG. 12, the marketing user 102 is provided with a business and demographic interface 1200 that provides selective options for designing the advertisement and promotion. A business category option 1202 opens up a scrolling menu to select a business category the marketing user 102 desires to market. A business hours option 1204 allows the marketing user 102 to select business hours, for example 9 am to 5 pm, at which the advertisement is operable from the electronic display 110. An age group option 1206 allows the marketing user 102 to select the demographic of potential targeted consumers. This option may require the targeted consumer 114a-b to first download information or the app from the marketing user 102, so that the marketing user 102 knows who is in the target geographic marketing area 118a-b.

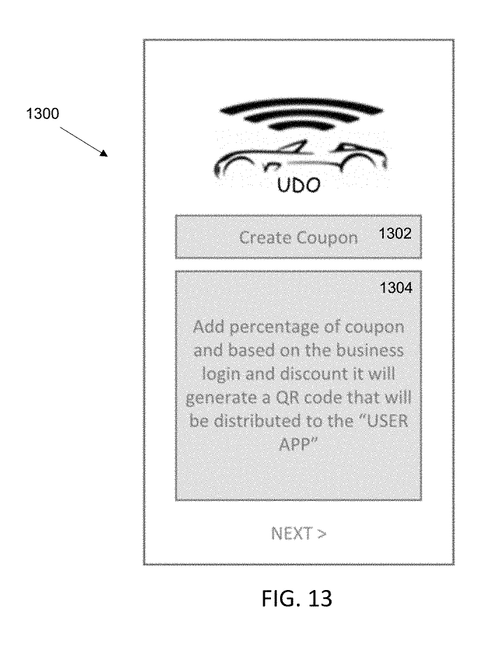

Turning now to FIG. 13, the system 100 allows the marketing user 102 to design and generate promotions, coupons, and other marketing means known in the art to attract and reward targeted consumers 114a-b. In some embodiments, a coupon interface 1300 provides the marketing user 102 with the option of adding a coupon 1302. The coupon may be in the form of a Quick Response (QR) code. Though any scanned coupon may also be used in other embodiments. A QR generation option 1304 enables the marketing user 102 to add a percentage of a coupon and, based on the business login, generate a QR code coupon that is transmitted to the targeted consumer 114a-b.

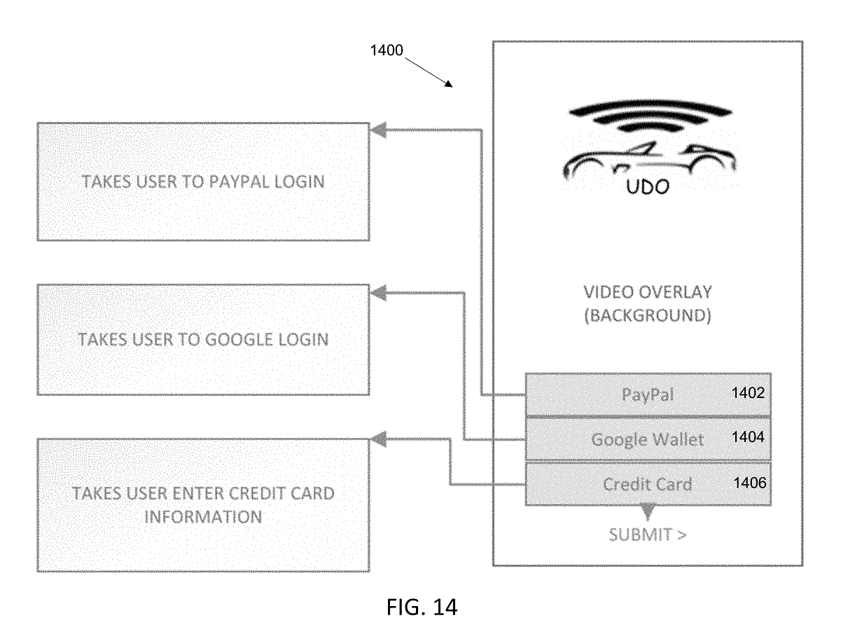

The marketing user 102 pays a driving user 104 to navigate through the geographic fence marketing perimeter 116a-b in the vehicle 106, while carrying the electronic display 110. In this manner, the marketing user 102 can optimize the marketing reach. The marketing user 102 has the option to pay the driving user 104 remotely through a payment interface 1400, shown in FIG. 14. The payment interface 1400 automates payment, so that the marketing user 102 can ensure that the electronic display 110 is navigating and visible in the target geographic marketing area 118a-b.

In one non-limiting embodiment, the payment interface 1400 provides the marketing user 102 with a Paypal™ option 1402. The Paypal™ option 1402 takes the marketing user 102 to the Paypal™ website to commence payment to the driving user 104. A Google Wallet™ option 1404 takes the marketing user 102 to the Google™ website to commence payment. A credit card option 1406 takes the marketing user 102 to a credit card page to commence payment.

A Step 706 includes navigating the vehicle, by a driving user, through the target geographical marketing area. The driving user 104 also has a portable communication device 112b for monitoring navigation through the digital geographic fence marketing perimeter 116a-b, payments received, and distance driven. The driving user must initially log in to the system 100 through a driver log in interface 1500. As FIG. 15 references, the driving user 104 initially logs into the system 100 on the portable communication device 112b through use of the driver log in interface 1500. The log in must be completed before the driving user 104 navigates the vehicle 106 with the mounted electronic display 110.

In some embodiments, the driving user 104 views a company logo 1502 representative of the marketing user at the top of the screen. The driving user 104 may also view a video background 1504 showing the product or service that is being marketed. This helps the driving user 104 to better understand the advertisement that is being navigated through the geographic fence marketing perimeter 116a-b. The driving user 104 may choose to log onto the system 100 through a Google™ account 1506 if the driving user 104 decides to use Google services. Once the driving user 104 selects the Google sign in, a pop-up icon 1508 for Google™ appears to enable log in.

In some embodiments, the driver log in interface 1500 allows the driving user 104 to log in to the system 100 through an existing Facebook™ account 1510 if the driving user 104 decides to use Facebook™ services. Once the driving user 104 selects the Google sign in, a pop-up icon 1512 for Facebook™ appears to enable log in. The driving user 104 also has the option of logging in through a server 1514, such as an iPAMN server, for example. Once the driving user 104 has logged into the server, a user name and password option 1516 appears for the driving user 104 to complete the log in. Thus, the driving user 104 has the option of logging in through Google™, Facebook™, and a server. Though in other embodiments, other log in options may be used.

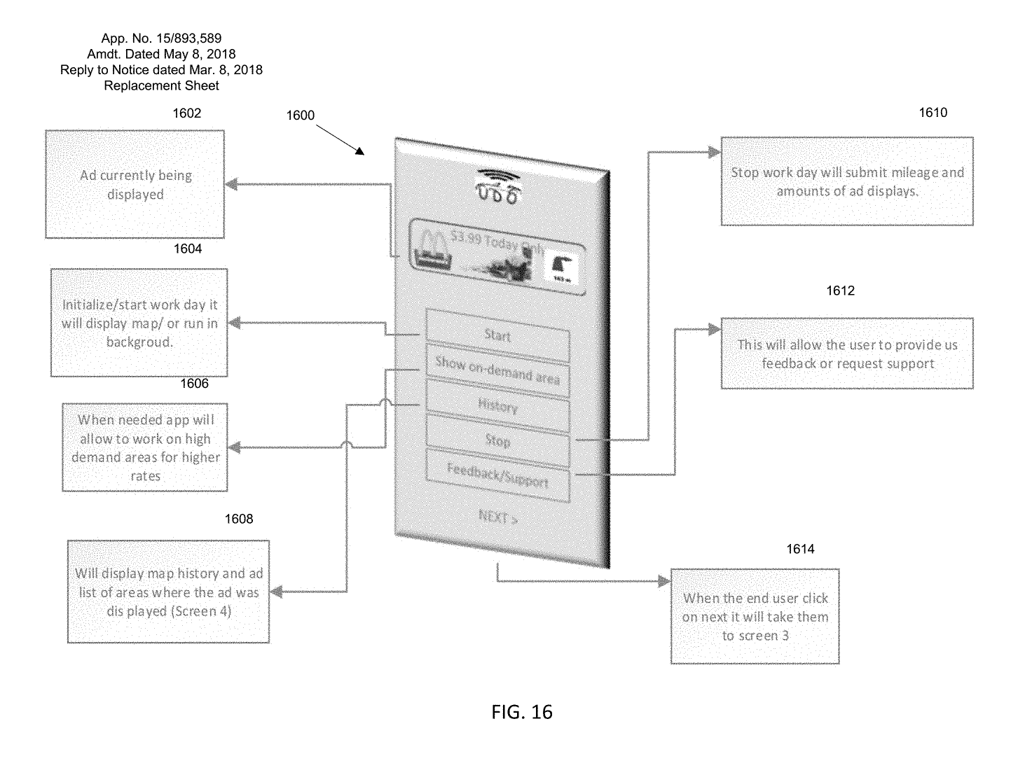

FIG. 16 references a driver work log interface 1600 that helps the driving user 104 keep track of driving parameters and hours worked, so as to record payments and condition of the vehicle 106. An advertisement display option 1602 allows the driving user 104 to see the advertisement or promotion present being displayed on the electronic display 110. The advertisement display option 1602 can be especially helpful when the driving user 104 cannot stop the vehicle to visually inspect the electronic display 110 from outside the vehicle 106.

In some embodiments, the advertisement display option 1602 allows the driving user 104 to start the work by initializing the interactive map with a start option 1604. Once the map is initiated, the driving user 104 may commence driving, and the electronic display 110 commences displaying the audio and visual digital content 120. In some embodiments, the target geographic marketing area 118a-b is busier in some periods; for example, during lunch hour, or at 5 pm. The driving user 104 can select a high demand option 1606 that pays the driving user 104 more for driving at these times, to optimize viewing by targeted consumers 114a-b.

In some embodiments, the driver work log interface 1600 provides a map history option 1608 that indicates the list of target geographic marketing areas 118a-b that the electronic display 110 was operational. After the driving user 104 has completed work, a finish option 1610 that summarizes the distance driven by the driving user 104 and the amount of audio and visual digital content 120 displayed in that work period. This can be helpful to both the driving user 104 and the marketing user 102 to keep track of payments. Finally, a feedback and support option 1612 allows the driving user 104 to provide feedback, which the marketing user 102 can view and analyze to enhance the system 100. In one embodiment, a next option 1614 moves the driving user 104 to another menu page.

In some embodiments, a Step 708 comprises locating a geographic position of at least one of a portable communication device of the driving user and an electronic display coupled to a window of a vehicle occupied by the driving user. This may be accomplished by the driving user 104 through a geographic driving area interface 1700, as shown in FIG. 17. The driving user 104 can better understand where to navigate the vehicle 106 for displaying the audio and visual digital content 120.

In one embodiment, the interactive map 1700 includes a company logo 1702. The interactive map also includes a map 1704 of the digital geographic fence marketing perimeter 116a that the driving user 104 can drag and zoom in and out of during navigation of the vehicle 106. An on-demand locator option 1706 allows the driving user 104 to know the areas where targeted consumers 114a-b are present, and thus, where the driving user 104 should be driving towards. A visual preview option 1708 allows the driving user 104 to view the high demand areas on the map 1704.

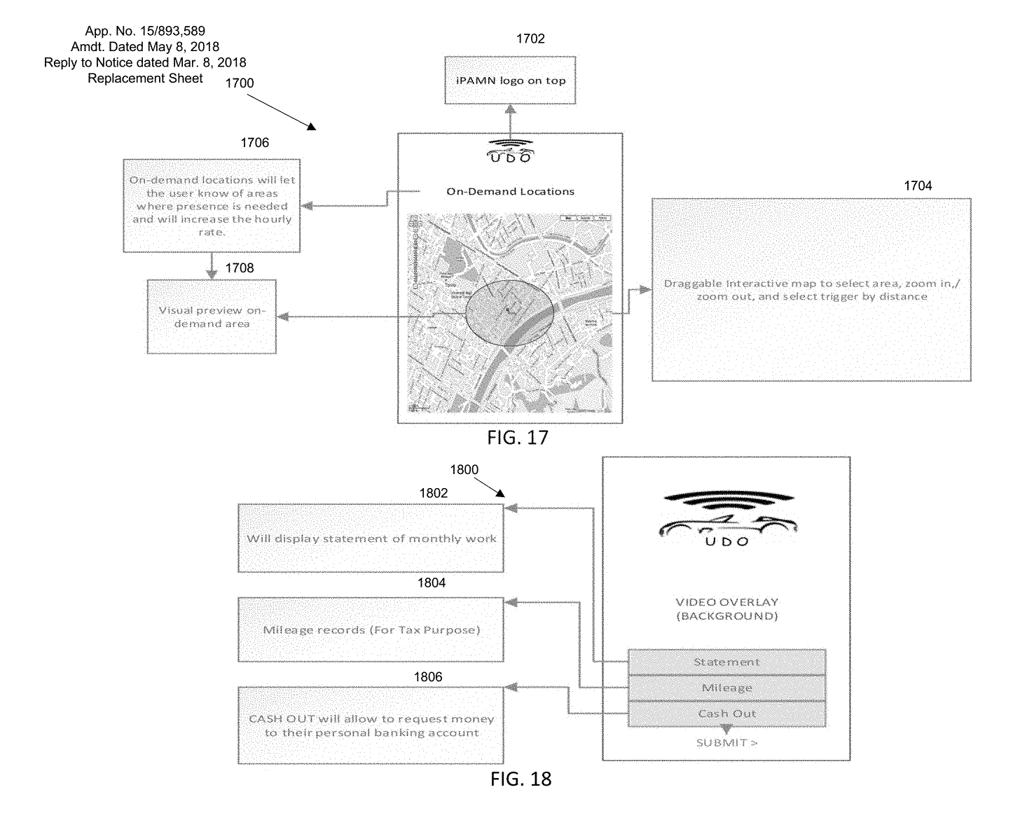

FIG. 18 references a financial records interface 1800 that allows the driving user 104 to record and view payments for time and distance driven in the geographic fence marketing perimeter 116a-b. A statement option 1802 displays a monthly, weekly, or annual statement for the driving user 104. A mileage record 1804 displays the number of miles driven by the vehicle 106. The distance may be recorded through GPS tracking means. Another option offered in the financial records interface 1800 is a cash out option 1806. The cash out option 1806 signals to the marketing user 102 to make payment to the driving user 104. The marketing user 102 may then pay the driving user 104 through the payment interface 1400 shown in FIG. 14.

A Step 710 includes communicating the at least one of the audio and visual digital content to the portable communication device of the driving user communicatively coupled to the at least one server over a network. The audio and visual digital content 120 is designed by the marketing user 102 to achieve optimal marketing effectiveness to the targeted consumer 114a-b. The wireless transmission triggers the audio and visual digital content 120 of the advertisement when the vehicle navigates within a predetermined range or distance of the geographic fence marketing perimeter 116a-b. In this manner, a target geographical marketing area 118a-b can be saturated with the advertisement or promotion.

In some embodiments, a Step 712 may include communicating, through the portable communication device, the at least one of the audio and visual content to a receiver communicatively coupled to the portable communication device, the receiver housed on the electronic display. The electrical and communication components of the driving user's 104 portable communication device 112b, as shown in FIGS. 15-18, may also serve as the communication means to relay or convey audio and/or visual content to the vehicle-mounted electronic display 110.

In other embodiments, electrical and communication components of the vehicle 106 may serve as the communication means to relay or convey audio and/or visual content to the vehicle-mounted electronic display 110, or components associated therewith, may house or store audio and/or visual content 120 for display based on the location of the display, i.e., determined by one or more location means such as a GPS.

A Step 714 comprises displaying, when the at least one of the portable communication device of the driving user and the electronic display is located within the digital geographic fence marketing perimeter, the at least one of an audio and visual content 120 on the electronic display 110. The disposition of the vehicle-mounted electronic display 110 provides a clear view of the audio and visual digital content 120 from the rear window.

The method 700 may also include a Step 716 that includes capturing an image with a camera of at least one of the following: a proximal vehicle, a license plate, a vehicle occupant, and a pedestrian. The camera 122 provides another effective means to direct the audio and visual digital content 120 towards the targeted consumer 114a-b. The captured image is used to identify and market to the targeted consumer 114a-b. The cameras 122 are operably configured to obtain vehicle identity information from vehicles and targeted consumers in proximity to the vehicle 106 of the driving user 104.

A step 718 includes identifying a targeted consumer based on at least one of the following: the captured image, a business category, business hours, an age group, a promotion, the captured image, at least one demographic data, a geographical marketing area, a time period, and an address. The targeted consumer 114a-b can simply view the audio and visual content 120 displayed on the electronic display 110. However, the targeted consumer 114a-b may also take a more proactive role in the marketing and promotion-gathering function by downloading the system 100 and downloading promotions offered by the marketing user 102.

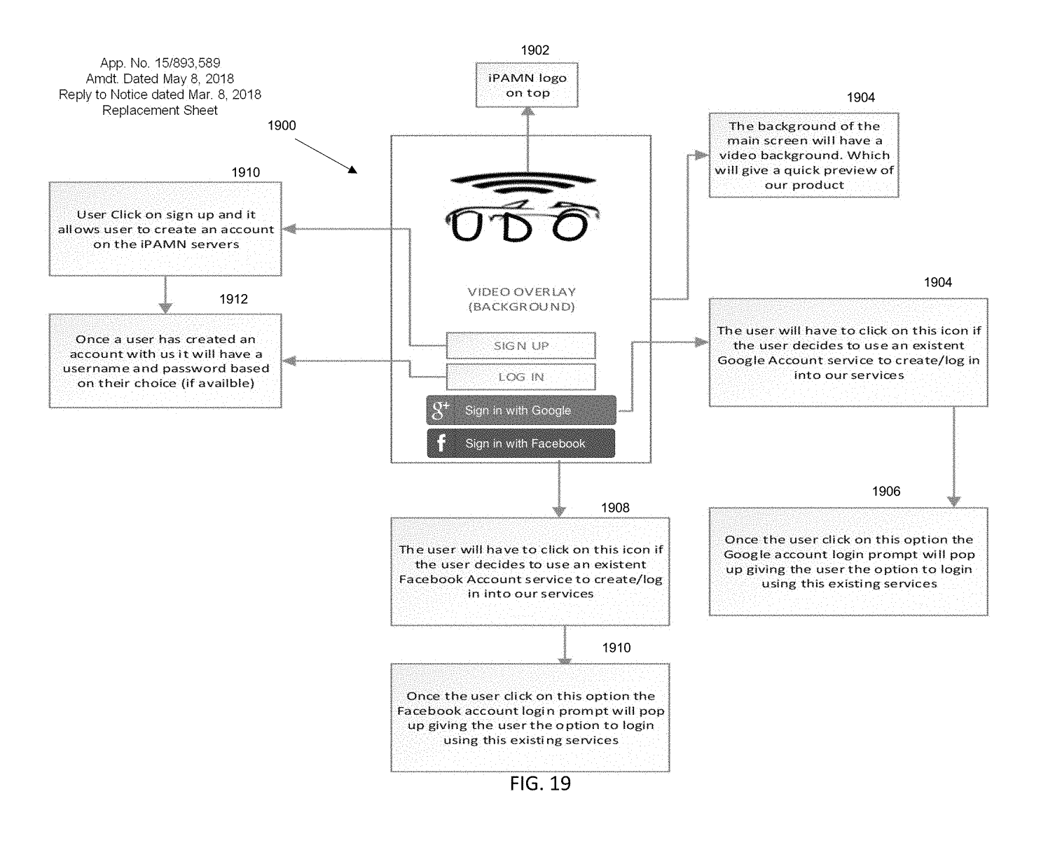

As FIG. 19 references, the targeted consumer 114a-b initially logs into the system 100 on the portable communication device 112c to view information about the marketing user 102, and to access the advertisements, promotions, addresses, directions, and others before accessing the promotions and marketing information offered by the marketing user 102. The targeted consumer 114a-b may utilize a consumer log in interface 1900 to access the advertisement and promotions offered by the marketing user 102.

In some embodiments, the targeted consumer 114a-b views a company logo 1902 representative of the marketing user at the top of the screen. The targeted consumer 114a-b may also view a video background 1904 showing the product or service that is being marketed. This helps the targeted consumer 114a-b to better understand the advertisement that is being offered for sale. The targeted consumer 114a-b may choose to log onto the system 100 through a Google™ account 1906 if the targeted consumer 114a-b decides to use Google services. Once the targeted consumer 114a-b selects the Google sign in, a pop-up icon 1908 for Google™ appears to enable log in.

In some embodiments, the consumer log in interface 1900 allows the targeted consumer 114a-b to log in to the system 100 through an existing Facebook™ account 1910 if the targeted consumer 114a-b decides to use Facebook™ services. Once the targeted consumer 114a-b selects the Google sign in, a pop-up icon 1912 for Facebook™ appears to enable log in. The targeted consumer 114a-b also has the option of logging in through a server 1914, such as an iPAMN server, for example. Once the targeted consumer 114a-b has logged into the server, a user name and password option 1916 appears for the user to complete the log in. Thus, the targeted consumer 114a-b has the option of logging in through Google™, Facebook™, and a server. Though in other embodiments, other log in options may be used.

In some embodiments, a Step 720 comprises displaying to the targeted consumer, through the electronic display, the audio and visual content. As the vehicle navigates through the geographic fence marketing perimeter 116a-b, the targeted consumer 114a-b is exposed to the audio and visual digital content 120. The driving user 104 may optimize viewing by driving through high demand areas 1606, as described in the driver work log interface 1600 shown in FIG. 16.

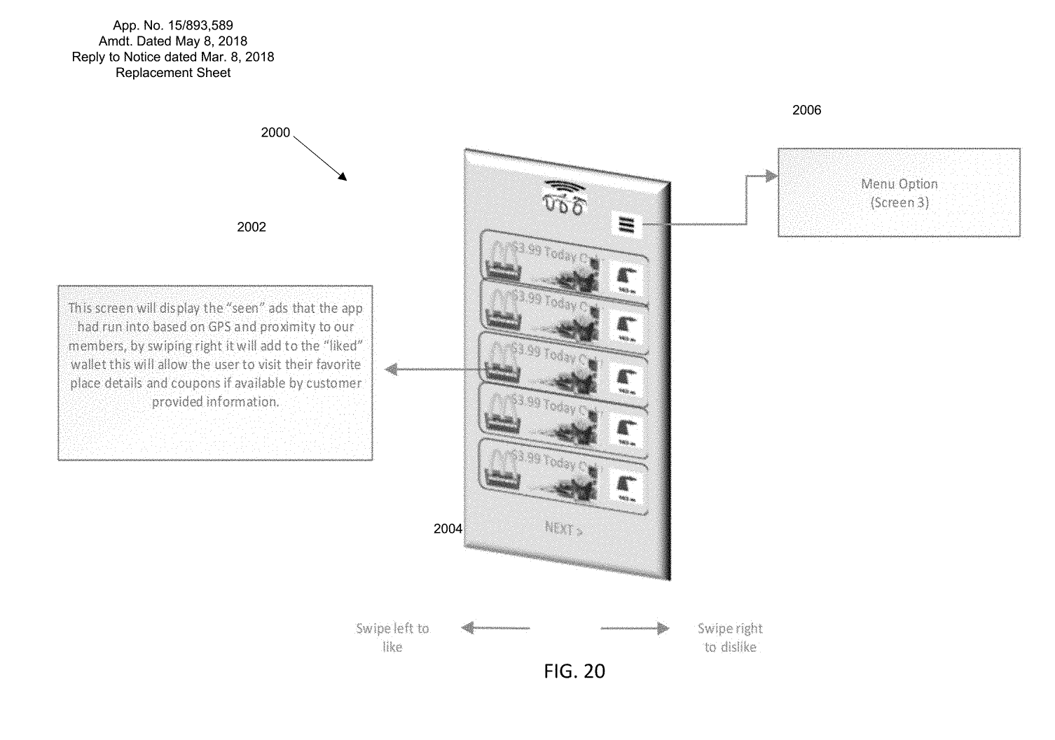

A Step 722 includes downloading, by the targeted consumer, a promotion or information pertinent to the marketing user, when the audio and visual content displays on the electronic display. FIG. 20 illustrates a promotion download interface 2000 that allows the targeted consumer 114a-b to view a promotion and select, save, like, unlike, or delete the promotion. A viewed promotion screen 2002 displays the advertisements and promotions that the targeted consumer 114a-b has viewed earlier, based on GPS location of the electronic display 110, or the targeted consumer's proximity to other targeted consumers.

In yet another embodiment, the promotion download interface 2000 provides a select like or unlike option 2004 that allows the targeted consumer 114a to like or unlike a promotion, simply by swiping the display screen of the portable communication device 112c. In one embodiment, swiping to the left indicates the targeted consumer 114a likes, or desires the promotion; and swiping the screen to the right indicates that the targeted consumer 114a dislikes, or finds minimal benefit from the advertisement or promotion. This serves as a rating system by targeted consumers 114a-b that helps the marketing user 102 to better understand the effectiveness of the advertisements and promotions. In yet another embodiment, a menu option 2006 is also used to provide the targeted consumer 114a with additional options.

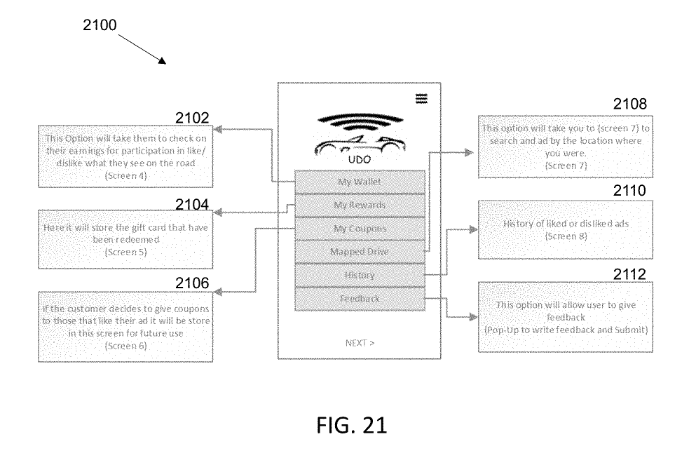

FIG. 21 references a rewards interface 2100 that supports a reward program for the targeted consumer 114a-b. Those skilled in the art will recognize that a rewards program, or loyalty program, is a structured marketing strategy designed by the marketing user 102 to encourage the targeted consumer 114a-b to continue to shop at or use the services of businesses associated with the marketing consumer 102. The rewards interface may include a My Wallet option 2102 that allows the targeted consumer 114a-b to view the number of points, stars, dollars, etc. available in the targeted consumer's 114a-b account.

In some embodiments, the rewards interface 2100 provides a My Rewards option 2104 that allows the targeted consumer 114a-b to store the reward. This may be a remote server or on the cloud. The rewards interface 2100 may further provide a My Coupons option 2106 that allows the targeted consumer 114a-b to store the coupons; and especially coupons provided for liking an advertisement or promotion.

In some embodiments, the rewards interface 2100 may further provide a Mapped Drive option 2108 that allows the targeted consumer 114a-b to view the map 2502 shown in FIG. 25, so as to view the geographic locations visited. The rewards interface 2100 may further provide a History option 2110 that allows the targeted consumer 114a-b to view a history of like and unlike advertisements and promotions. The rewards interface 2100 may further provide a Feedback option 2110 that allows the targeted consumer 114a-b to provide feedback and comments for the viewed advertisements and promotions. This helps the marketing user 102 better understand the status of the advertising campaign and the effectiveness of the driving user 104.

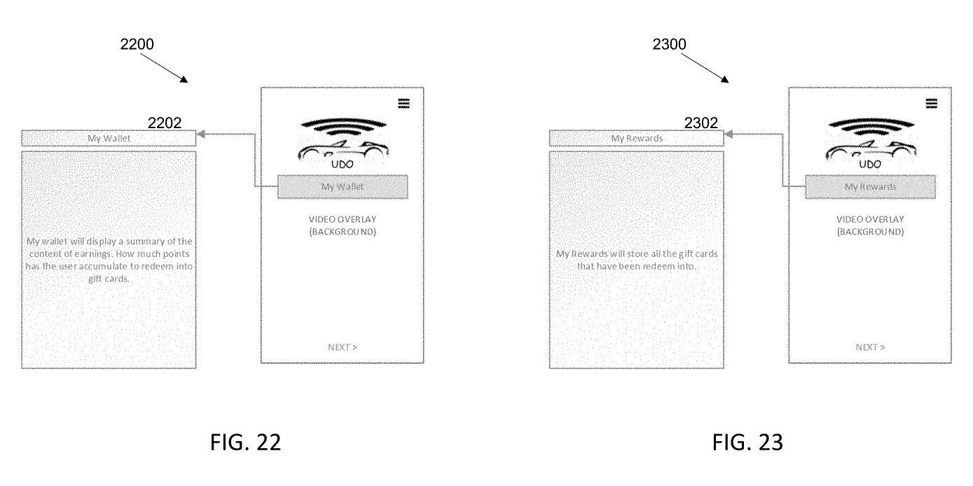

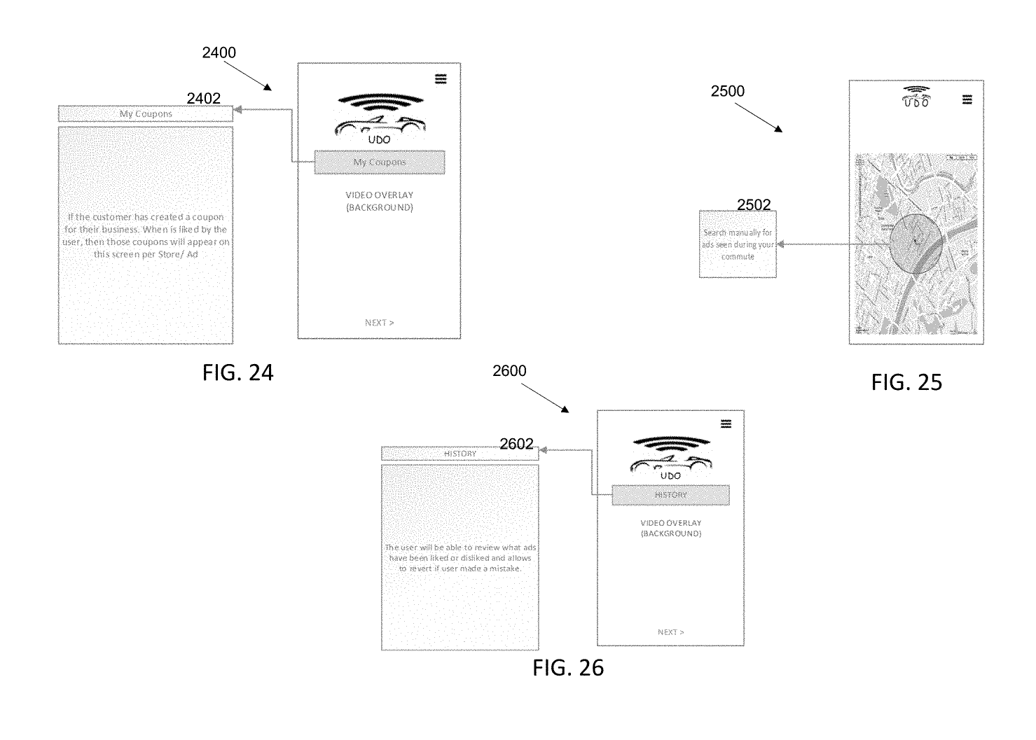

FIG. 22 references an earnings summary interface 2200 that is used to show the targeted consumer 114a-b the number of points, stars, dollars, etc. accumulated and available in the targeted consumer's 114a-b account. A Wallet 2202 feature provides a visual display of the rewards. This is similar to the My Wallet option 2102 shown in FIG. 21. FIG. 23 references a gift cards interface 2300 that shows the targeted consumer 114a-b the number of gift cards accumulated and available in the targeted consumer's 114a-b account. A Rewards 2302 feature provides a visual display of the gift cards. FIG. 24 references a coupons interface 2400 that shows the targeted consumer 114a-b the number of coupons accumulated and available in the targeted consumer's 114a-b account. A Coupons 2402 feature provides a visual display of the coupons.

FIG. 25 references a target area interface 2500 for the targeted consumer 114a-b to view. In one embodiment, the target area interface 2500 provides an interactive map 2502 of the digital geographic fence marketing perimeter 116a that the targeted consumer 114a-b can drag and zoom in and out of to track the vehicle 106 carrying the electronic display 110.

FIG. 26 references a promotion like or unlike interface 2600 that allows the targeted consumer 114a-b to view advertisements and promotions that have been liked or disliked from the like/unlike option 2004 discussed above. This not only helps the targeted consumer 114a-b remember preferred promotions, but also allows the marketing user 102 to better understand the effectiveness of the advertisements and promotions. A like and unlike option 2602 allows the targeted consumer 114a-b to revert the selection if a mistake has been made, or if the targeted consumer 114a-b changes opinion about the advertisement or promotion.

In some embodiments, a Step 724 may include paying, by the marketing user, the driving user for coupling the electronic display to the window of the vehicle, maintaining communication between the portable communication device and the at least one server, and navigating through the preferred target geographic marketing area. As discussed above in FIG. 14, a payment interface 1400 automates payment, so that the marketing user 102 can ensure that the electronic display 110 is navigating and visible in the target geographic marketing area 118a-b. Similarly, the driving user 104 is provided with the cash out option 1806 that signals to the marketing user 102 to make payment to the driving user 104. The marketing user 102 may then pay the driving user 104 through the payment interface 1400 shown in FIG. 14.

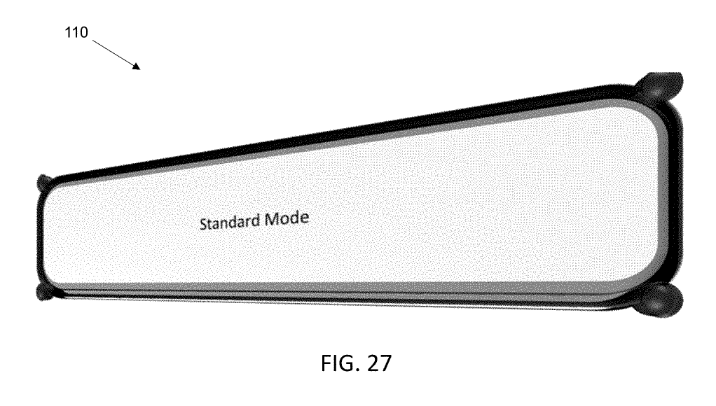

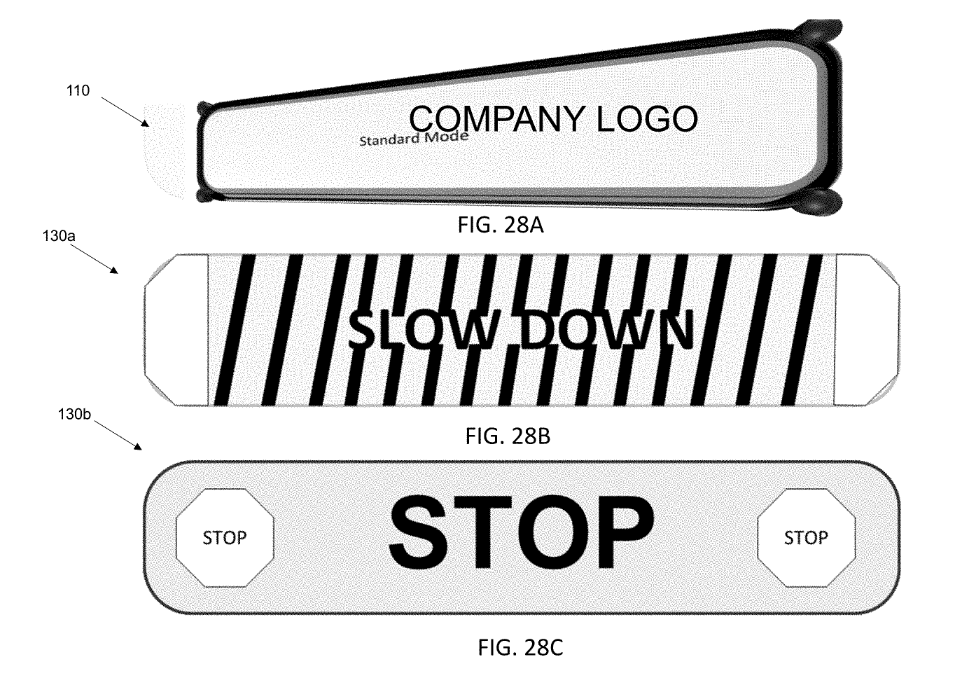

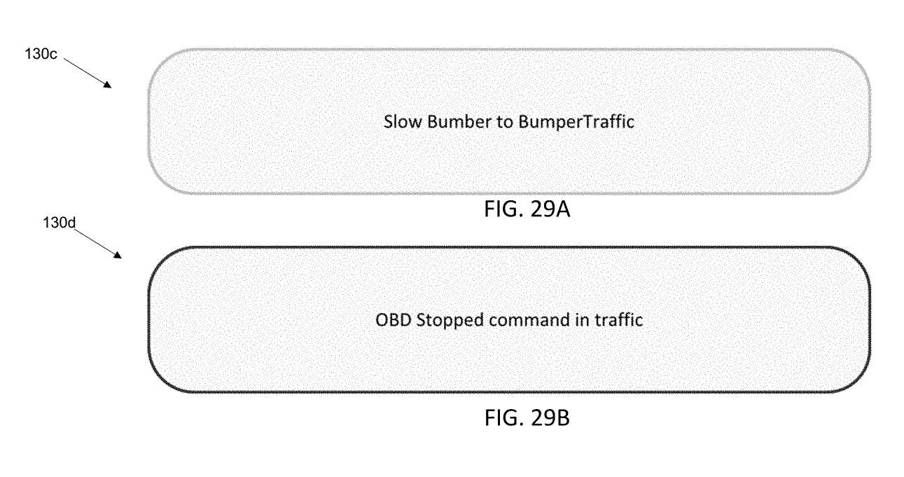

A final Step 726 includes displaying a dynamic traffic message when a traffic event occurs. This unique feature interrupts the advertisement to display a message about a traffic event—generally for safety reasons. As FIG. 27 references, a standard vehicle-mounted electronic display 110 is used to display the audio and visual digital content 120 for the advertisement. However, the system 100 is unique in that the electronic display 110 can also display a dynamic traffic message 130a-d when a traffic event occurs. The dynamic traffic message 130a-d supersedes the audio and visual content 120 of the advertisement for enhanced traffic safety. Exemplary dynamic traffic messages 130a-d may include, without limitation, “Slow Down” 130a (FIG. 28B); “stop” 130b (FIG. 28C); “Slow Bumper to Bumper Traffic” 130c (FIG. 29A); and “OBD Stop command in Traffic” 130d (FIG. 29B). After emitting the dynamic traffic messages 130a-d, the electronic display returns to the standard advertisement mode, as shown in FIG. 28A.

Referring now to FIG. 30, one embodiment of the present invention is shown as a block diagram, illustrating an exemplary network of data processing system in which the present invention may be implemented. FIG. 30 shows several advantageous features of the present invention, but, as will be described below, the invention can be provided in several shapes, sizes, combinations of features and components, and varying numbers and functions of the components. The first example of a network 1100, as shown in FIG. 30, includes connections 3002a-c, which are the medium used to provide communication links between various devices and computers connected together within the network 3000. The connections 3002a-c may be wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention.

In the depicted example, the network 3000 includes a personal mobile computing device 3004, a server 3006, and vehicle-mounted display 3004. The personal mobile computing device 3004, e.g., a user's cellphone, can be operable to execute programming instructions embodied in a software application that can be received from an administrative server 3006 via a wide area network (WAN) 3010. In other embodiments, the personal computer 3004 is operable to execute the programming instructions received from the server 3006 over the WAN 3010. In yet other embodiments, the software application is a web-based software application, a desktop software application, or a mobile device software app. In one embodiment, the WAN is the Internet. The Internet represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network 3000 also may be implemented as a number of different types of networks, such as for example, an Intranet, a local area network (LAN), or a cellular network. FIG. 30 is intended as an example, and not as an architectural limitation for the present invention.

The server 3006 can be seen as a computer that manages access to a centralized resource or database, e.g., audio and/or visual content for communication to a user's mobile device (which may be communicatively coupled to the vehicle-mounted display) and/or the vehicle-mounted display. In some embodiments, users can request and/or download the software application embodying an exemplary method of the present invention on their cellular phone. The server 3006 can receive, process, and satisfy the request by sending the software application to the personal mobile computing device 3004 via the WAN 3010. In yet other embodiments, the vehicle-mounted display 3008 can receive consent based on a location of the vehicle and/or user's cellphone, and the server 3006 can receive, process, and satisfy the request by sending said content via the WAN 3010.

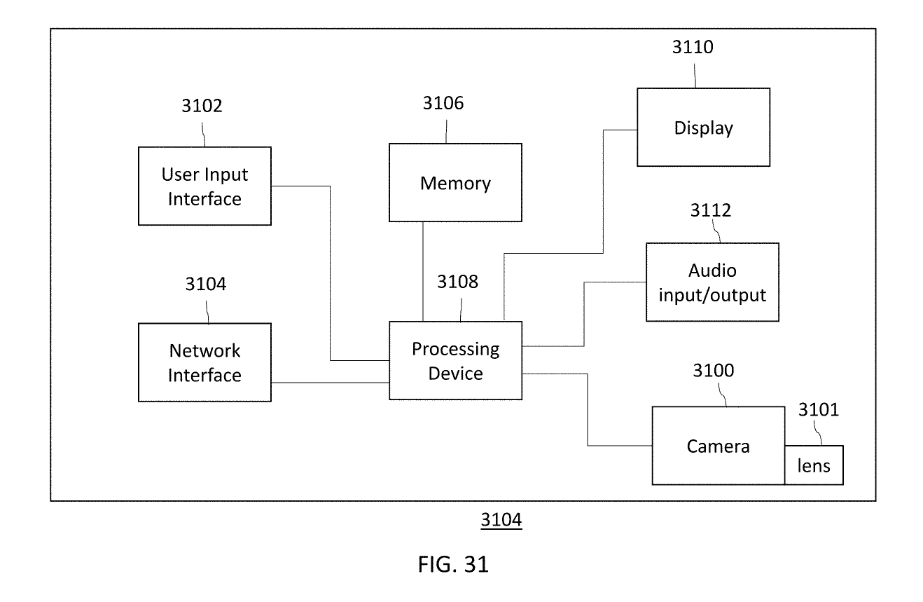

With reference now to FIG. 31, the personal computing device 3004 and/or vehicle-mounted display 3008 is illustrated in a block diagram. The personal computing device 3004 and/or vehicle-mounted display 3008 may include a camera 3100, a user input interface 3102, a network interface 3104, a memory 3106, a processing device 3108, a computer display 3110, and an audio input/output 3112.

The camera 3100 may include a camera lens 3101 and may be operable to capture still images, as well as, video. The camera 3100 is preferably a digital camera so that the images may be stored in the memory 3106 and processed by the processing device 3108 on a user's cellular phone and/or remotely at the administrator server 3006. The camera 3100 may be communicatively coupled to a microphone for capturing audio, as well as, simultaneous visual video images.

The user input interface 3102 functions to provide the user a method of providing input to the personal computing device 3004, e.g., on the interfaces depicted in FIGS. 9-26. The user input interface 3102 may also facilitate interaction between the user and the device 3004. The user input interface 3102 may be a keypad providing a variety of user input operations. For example, the keypad may include alphanumeric keys for allowing entry of alphanumeric information (e.g. telephone numbers, contact information, content for display, text, etc.). The user input interface 3102 may include special function keys (e.g. a camera shutter button, volume control buttons, back buttons, home button, etc.), navigation and select keys, a pointing device, and the like. Keys, buttons, and/or keypads may be implemented as a touchscreen associated with the computer display 3110. The touchscreen may also provide output or feedback to the user, such as haptic feedback or orientation adjustments of the keypad according to sensor signals received by motion detectors, such as an accelerometer, located within the device 3004.

The network interfaces 3104 may include one or more network interface cards (NIC) or a network controller. In some embodiments, the network interface1 3104 may include a personal area network (PAN) interface. The PAN interface may provide the capability for the personal computing device 3004 to network using a short-range communication protocol, for example, a Bluetooth communication protocol. The PAN interface may permit one personal computing device 3004 to connect wirelessly to another personal computing device 3004 via a peer-to-peer connection.

The network interfaces 3104 may also include a local area network (LAN) interface. The LAN interface may be, for example, an interface to a wireless LAN, such as a Wi-Fi network. The range of the LAN interface may generally exceed the range available via the PAN interface. Typically, a connection between two electronic devices via the LAN interface may involve communication through a network router or other intermediary device.

Additionally, the network interfaces 3104 may include the capability to connect to a wide area network (WAN) via a WAN interface. The WAN interface may permit a connection to, for example, a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

The personal computing device 3004 may also include a near field communication (NFC) interface. The NFC interface may allow for extremely close-range communication at relatively low data rates (e.g., 424 kb/s). The NFC interface may take place via magnetic field induction, allowing the NFC interface to communicate with other NFC interfaces located on other mobile computing devices 3004 or to retrieve information from tags having radio frequency identification (RFID) circuitry. The NFC interface may enable initiation and/or facilitation of data transfer from one personal computing device 3004 to another computing device with an extremely close range (e.g. 4 centimeters).

A memory 3106 associated with the device 3004 and/or vehicle-mounted display 3008 may be, for example, one or more buffer, a flash memory, or non-volatile memory, such as random-access memory (RAM). The personal computing device 3004 may also include non-volatile storage. The non-volatile storage may represent any suitable storage medium, such as a hard disk drive or non-volatile memory, such as flash memory.

The processing device 3108 can be, for example, a central processing unit (CPU), a microcontroller, or a microprocessing device, including a “general purpose” microprocessing device or a special purpose microprocessing device. The processing device 3108 executes code stored in memory 3106 in order to carry out operation/instructions of the personal mobile computing device 3004 and/or vehicle-mounted display 3008. The processing device 3108 may provide the processing capability to execute an operating system, run various applications, and provide processing for one or more of the techniques described herein.

The computer display 3110 displays information regarding the content desired to be advertised to surrounding vehicles and, with respect to the user's cellular phone, to the user such as the content of the display, time, telephone numbers, various menus, application icons, pull-down menus, and the like. The computer display 3110 may be used to present various images, text, graphics, or videos to the user, such as photographs, mobile television content, Internet webpages, and mobile application interfaces. The computer display 3110 may be any type of suitable display, such as a liquid-crystal display (LCD), a plasma display, a light-emitting diode (LED) display, or the like.

The personal computing device 3004 and/or vehicle-mounted display 3008 may include audio input and output structures 3112, such as a microphone for receiving audio signals from a user and/or a speaker for outputting audio signals, such as audio recordings associated with food (e.g., a person chewing the food), and the like. The personal computing device 3004 may also include an audio port for connection to peripheral audio input and output structures, such as a headset, or peripheral speakers or microphones.

Some of the figures have been described in conjunction with the process flow charts. Although said flow charts show a specific order of executing the process steps, the order of executing the steps may be changed relative to the order shown in certain embodiments. Also, two or more blocks shown in succession may be executed concurrently or with partial concurrence in some embodiments. Certain steps may also be omitted for the sake of brevity. In some embodiments, some or all of the process steps can be combined into a single process.

1. A method of directed advertising on a vehicle-mounted display comprising the steps of:
coupling an electronic display to a rear window of a vehicle occupied by a driving user by pressing a plurality of suction cups directly coupled to the electronic display against the rear window, the vehicle having an interior area and the electronic display securely retained on and flush against the rear window of the vehicle and with a front face of the electronic display facing outwardly away from the interior rear to face an ambient environment for viewing by a surrounding public;
receiving, through at least one server, from a marketing user:
a digital geographic fence marketing perimeter representing a target geographic marketing area; and
at least one of an audio and visual digital content identifying a business of the marketing user;
locating a geographic position of at least one of a portable communication device of the driving user and the electronic display coupled to the rear window of the vehicle occupied by the driving user;
communicating the at least one of the audio and visual digital content to the portable communication device of the driving user communicatively coupled to the at least one server over a network;
communicating, through the portable communication device of the driving user acting as a relay, the at least one of the audio and visual content to a receiver communicatively coupled to the portable communication device of the driving user, the receiver housed on the electronic display; and
displaying, when the at least one of the portable communication device of the driving user and the electronic display is located within the digital geographic fence marketing perimeter, the at least one of an audio and visual content on the electronic display coupled to the rear window of the vehicle occupied by the driving user.

2. The method of claim 1, wherein the digital geographic fence marketing perimeter comprises a unit of length, a radius, a neighborhood, and a highway.

3. The method of claim 1, wherein the digital geographical fence marketing perimeter comprises an interactive map.

4. The method of claim 1, wherein the audio and visual digital content includes at least one of the following: a company logo, a promotion, a price list, a direction, a website address, a phone number, and a physical address.

5. The method of claim 1, further comprising a step of configuring a marketing layout by the marketing user for the audio and visual digital content.

6. The method of claim 5, wherein the step of configuring a marketing layout, includes at least one of the following: uploading a graphic, uploading a video, entering coordinates for the digital geographic fence marketing perimeter, viewing layout option of the audio and visual digital content, and viewing a full screen preview of the audio and visual digital content.

7. The method of claim 1, further comprising a step of capturing an image with a camera of at least one of the following: a proximal vehicle, a license plate, a vehicle occupant, and a pedestrian.

8. The method of claim 7, further comprising a step of identifying a targeted consumer based on at least one of the following: the captured image, a business category, business hours, an age group, a promotion, at least one demographic data, a geographical marketing area, a time period, and an address.

9. The method of claim 8, further comprising a step of displaying to the targeted consumer, through the electronic display, the audio and visual content.

10. The method of claim 9, further comprising a step of downloading, by the targeted consumer, a promotion or information pertinent to the marketing user, when the audio and visual content displays on the electronic display.

11. The method of claim 10, wherein the promotion or information pertinent to the marketing user is configured as a quick response code.

12. The method of claim 1, further comprising a step of navigating the vehicle, by the driving user, through the target geographical marketing area.

13. The method of claim 12, wherein the step of navigating the vehicle, by the driving user, through the target geographical marketing area, further comprises indicating to the driving user, by the marketing user, a preferred target geographic marketing area.

14. The method of claim 13, further comprising a step of paying, by the marketing user, the driving user for coupling the electronic display to the rear window of the vehicle, maintaining communication between the portable communication device and the at least one server, and navigating through the preferred target geographic marketing area.

15. The method of claim 1, further comprising a step of, displaying on the portable communication device, by the driving user, at least one of the following: a monthly statement, a distance driven, and a payment request.

16. The method of claim 1, further comprising a step of displaying a dynamic traffic message when a traffic event occurs.

17. A method of directed advertising on a vehicle-mounted display comprising the steps of:
coupling an electronic display to a rear window of a vehicle occupied by a driving user by pressing a plurality of suction cups directly coupled to the electronic display against the rear window, the vehicle having an interior area and the electronic display securely retained on and flush against the rear window of the vehicle and with a front face of the electronic display facing outwardly away from the interior rear to face an ambient environment for viewing by a surrounding public;
configuring a marketing layout, by a marketing user, for at least one of an audio and visual digital content operably configured to display on the electronic display coupled to the rear window of the vehicle;
receiving, through at least one server, from the marketing user:
a digital geographic fence marketing perimeter representing a target geographic marketing area; and
the audio and visual digital content identifying a business of the marketing user;
navigating the vehicle, by the driving user, through the target geographical marketing area;
locating a geographic position of at least one of a portable communication device of the driving user and an electronic display coupled to the rear window of the vehicle occupied by the driving user;
communicating the at least one of the audio and visual digital content to the portable communication device of the driving user communicatively coupled to the at least one server over a network;
communicating, through the portable communication device of the driving user acting as a relay, the at least one of the audio and visual content to a receiver communicatively coupled to the portable communication device, the receiver housed on the electronic display;
displaying, when the at least one of the portable communication device of the driving user and the electronic display is located within the digital geographic fence marketing perimeter, the at least one of an audio and visual content on the electronic display;
capturing an image with a camera of at least one of the following: a proximal vehicle, a license plate, a vehicle occupant, and a pedestrian;
identifying a targeted consumer based on at least one of the following: the captured image, a business category, business hours, an age group, a promotion, the captured image, at least one demographic data, a geographical marketing area, a time period, and an address;
displaying to the targeted consumer, through the electronic display, the audio and visual content;
downloading, by the targeted consumer, a promotion or information pertinent to the marketing user, when the audio and visual content displays on the electronic display;
paying, by the marketing user, the driving user for coupling the electronic display to the rear window of the vehicle, maintaining communication between the portable communication device and the at least one server, and navigating through the preferred target geographic marketing area; and
superseding the audio and visual content on the electronic display to display a dynamic traffic message when a traffic event occurs and, after displaying the dynamic traffic message, returning to display the audio and visual content on the electronic display.

18. The method of claim 17, wherein the step of configuring a marketing layout, includes at least one of the following: uploading a graphic, uploading a video, entering coordinates for the digital geographic fence marketing perimeter, viewing layout option of the audio and visual digital content, and viewing a full screen preview of the audio and visual digital content.

19. The method of claim 17, further comprising a step of, displaying on the portable communication device, by the driving user, at least one of the following: a monthly statement, a distance driven, and a payment request.

20. A system for directed advertising on a vehicle-mounted display, comprising:
a digital geographic fence marketing perimeter representing a target geographic marketing area, the target geographic marketing area determined by a marketing user;
at least one of an audio and visual digital content stored on at least one server, the audio and visual digital content configured by the marketing user;
an electronic display, having a plurality of suction cups directly coupled to the electronic display, coupled with the plurality of suction cups to a rear window of a vehicle occupied by a driving user, the vehicle having an interior area and the electronic display securely retained on and flush against the rear window of the vehicle and with a front face of the electronic display facing outwardly away from the interior rear to face an ambient environment for viewing by a surrounding public and being in communication with the at least one server over a network, whereby the audio and visual digital content is communicated to the electronic display over a network;
a portable communication device operable by a driving user, the portable communication device comprising a receiver, the receiver enabling geographic identification of the driving user and the electronic display within the digital geographic fence marketing perimeter;
a camera operatively coupled to the electronic display, the camera operable to capture an image of at least one of the following: a targeted consumer, a proximal vehicle, a license plate, a vehicle occupant, and a pedestrian, whereby the audio and visual content is displayed to the targeted consumer through the portable communication device of the driving user and acting as a relay to the electronic display; and
a dynamic traffic message displaying on the electronic display when a traffic event occurs.
